(19) United States
(12) Patent Application Publication
(10) Pub. No.: US 2024/0120664 A1
(43) Pub. Date: Apr. 11, 2024

(54) ANTENNA DEVICE AND WINDOW GLASS FOR BUILDING

(71) Applicant: AGC Inc., Tokyo (JP)

(72) Inventors: Yasuo MORIMOTO, Tokyo (JP); Fuminori WATANABE, Tokyo (JP); Shimpei NAGAE, Tokyo (JP); Ryuta SONODA, Tokyo (JP); Tetsuya HIRAMATSU, Tokyo (JP)

(73) Assignee: AGC Inc., Tokyo (JP)

(21) Appl. No.: 18/537,887

(22) Filed: Dec. 13, 2023

Related U.S. Application Data
(63) Continuation of application No. PCT/JP2022/023671, filed on Jun. 13, 2022.

(30) Foreign Application Priority Data
Jun. 18, 2021 (JP) 2021-101913
Nov. 29, 2021 (JP) 2021-193215

(51) Int. Cl. H01Q 21/12; H01Q 1/40; H01Q 15/08

(52) U.S. Cl. CPC H01Q 21/12; H01Q 1/40; H01Q 15/08

(57) ABSTRACT

An antenna device includes an array antenna configured to radiate a radio wave. The array antenna includes at least four radiating elements arranged substantially parallel to a beam scanning plane of the radio wave. The at least four radiating elements are arranged substantially parallel to a first principal surface of window glass for a building, with the antenna device arranged such that the array antenna is arranged at the first principal surface of the window glass in a non-contact manner and such that the radio wave is radiated toward a second principal surface of the window glass opposite from the first principal surface.

### CROSS-REFERENCE TO RELATED APPLICATIONS

This application is a continuation of International Application PCT/JP2022/023671, filed on Jun. 13, 2022 and designated the U.S., which is based on and claims priority to Japanese Patent Application No. 2021-101913 filed on Jun. 18, 2021 and Japanese Patent Application No. 2021-193215 filed on Nov. 29, 2021, with the Japanese Patent Office. The entire contents of these applications are incorporated herein by reference.

### BACKGROUND OF THE INVENTION

### 1. Field of the Invention

The present disclosure relates to an antenna device and window glass for a building provided with the antenna device.

### 2. Description of the Related Art

A technique for improving radio wave transmission performance by installing a radio wave transmission body covering an antenna so as to face a building finishing material such as window glass (for example, see Japanese Unexamined Patent Application Publication No. H6-196915) is known.

In recent years, a fifth generation mobile communication system (5G), a sixth generation mobile communication system (6G), or the like has been developed as a communication technology for mobile communication devices such as smartphones, tablets, mobile phones, and notebook computers.

### SUMMARY

According to an aspect of the present disclosure, an antenna device includes an array antenna configured to radiate a radio wave. The array antenna includes at least four radiating elements arranged substantially parallel to a beam scanning plane of the radio wave. The at least four radiating elements are arranged substantially parallel to a first principal surface of window glass for a building, with the antenna device arranged such that the array antenna is arranged at the first principal surface of the window glass in a non-contact manner and such that the radio wave is radiated toward a second principal surface of the window glass opposite from the first principal surface. According to an aspect of the present disclosure, window glass for a building is provided with the antenna device.

### BRIEF DESCRIPTION OF DRAWINGS

FIG. 1 is a diagram illustrating an indoor side arrangement example of an antenna device according to an embodiment of the present disclosure;

FIG. 2 is a cross-sectional diagram schematically illustrating an example of a laminated configuration of window glass with the antenna device according to the embodiment of the present disclosure;

FIG. 3A is a diagram illustrating a case where a single glass is present close to the antenna;

FIG. 3B is a diagram illustrating a case where an insulated glass is present close to the antenna;

FIG. 3C is a diagram illustrating a case where the single glass is present close to the antenna having a ground layer;

FIG. 4 is a diagram illustrating an ideal model which is a single-element infinite periodic analysis model constituted by a patch antenna;

FIG. 5A is an overall perspective view illustrating a real model in which the insulated glass is disposed close to one antenna element constituted by the patch antenna;

FIG. 5B is an enlarged perspective view of a quadrilateral portion of the real model in FIG. 5A illustrating the antenna element to be excited and feed points;

FIG. 6 is a cross-sectional view of analysis models in which the antenna element is disposed apart from the insulated glass with a matching layer;

FIG. 7 is a graph illustrating the gains of TE incidence in the ideal model of FIG. 4 and the real model of 5A;

FIG. 8 is a graph illustrating the gains of TM incidence in the ideal model of FIG. 4 and the real model of 5A;

FIG. 9A is an overall perspective view of a real model in which thirty two antenna elements are arranged in a scanning direction and at a distance apart from the insulated glass when TE incidence is simulated;

FIG. 9B is an enlarged perspective view of a quadrilateral portion of the real model in FIG. 9A;

FIG. 9C is a top view illustrating positions of the feed points on an array antenna included in the real model of FIG. 9A;

FIG. 10A is an overall perspective view of a real model in which thirty two antenna elements are arranged in the scanning direction and at a distance apart from insulated glass when TM incidence is simulated;

FIG. 10B is an enlarged perspective view of a quadrilateral portion of the real model in FIG. 10A;

FIG. 10C is a top view illustrating positions of the feed points on the array antenna included in the real model of FIG. 10A;

FIG. 11 is a graph illustrating the gains of TE incidence at target angles of 0°, 20°, 40°, and 60° in the case of the ideal model and in a case where thirty two antenna elements are arranged in the scanning direction and at 20 mm apart from the insulated glass;

FIG. 12 is a graph illustrating the gains of TM incidence at the target angles of 0°, 20°, 40°, and 60° in the case of the ideal model and in the case where thirty two antenna elements are arranged in the scanning direction and at 20 mm apart from the insulated glass;

FIG. 13 is a graph illustrating the gains of TE incidence at the target angles of 0°, 20°, 40°, and 60° in the case of the ideal model and in a case where two antenna elements are arranged in the scanning direction and at 20 mm apart from the insulated glass;

FIG. 14 is a graph illustrating the gains of TM incidence at the target angles of 0°, 20°, 40°, and 60° in the case of the ideal model and in the case where two antenna elements are arranged in the scanning direction and at 20 mm apart from the insulated glass;

FIG. 15 is a table illustrating correlation coefficients between the value in the real model and the value in the ideal model at each angle in a case where a number of antenna elements is arranged at 20 mm apart from the insulated glass, the number of antenna elements being one, two, four, eight, sixteen, and thirty two;

FIG. 16 is a diagram illustrating the peak gains of TE incidence around the target angles of 0°, 20°, 40°, and 60° in the case where the numbers of antenna elements arranged at 20 mm apart from the insulated glass are four, eight, sixteen, and thirty two;

FIG. 17 is a diagram illustrating the peak gains of TM incidence around the target angles of 0°, 20°, 40°, and 60° in the case where the numbers of antenna elements arranged at 20 mm apart from the insulated glass are four, eight, sixteen, and thirty two;

FIG. 18 is a graph illustrating the gains of TE incidence at the target angles of 0°, 20°, 40°, and 60° in the case of the ideal model and in a case where thirty two antenna elements are arranged in the scanning direction and at 5 mm apart from the insulated glass;

FIG. 19 is a graph illustrating the gains of TM incidence at the target angles of 0°, 20°, 40°, and 60° in the case of the ideal model and in the case where thirty two antenna elements are arranged in the scanning direction and at 5 mm apart from the insulated glass;

FIG. 20 is a graph illustrating the gains of TE incidence at the target angles of 0°, 20°, 40°, and 60° in the case of the ideal model and in a case where thirty two antenna elements are arranged in the scanning direction and at 10 mm apart from the insulated glass;

FIG. 21 is a graph illustrating the gains of TM incidence at the target angles of 0°, 20°, 40°, and 60° in the case of the ideal model and in the case where thirty two antenna elements are arranged in the scanning direction at 10 mm apart from the insulated glass;

FIG. 22 is a graph illustrating the gains of TE incidence at the target angles of 0°, 20°, 40°, and 60° in the case of the ideal model and in a case where thirty two antenna elements are arranged in the scanning direction and at 50 mm apart from the insulated glass;

FIG. 23 is a graph illustrating the gains of TM incidence at the target angles of 0°, 20°, 40°, and 60° in the case of the ideal model and in the case where thirty two antenna elements are arranged in the scanning direction at 50 mm apart from the insulated glass;

FIG. 24 is a table illustrating correlation coefficients between the value in the real model and the value in the ideal model at each angle in a case where thirty two antenna elements are arranged at a distance apart from the insulated glass, the distance being 5, 10, 20, 30, 40, and 50 mm;

FIG. 25 is a cross-sectional view of analysis models in which an antenna element is disposed apart from a single glass with a matching layer;

FIG. 26 is a graph illustrating the gains of TE incidence at the target angles of 0°, 20°, 40°, and 60° in the case of the ideal model and in a case where thirty two antenna elements are arranged in the scanning direction and at 5 mm apart from the single glass;

FIG. 27 is a graph illustrating the gains of TM incidence at the target angles of 0°, 20°, 40°, and 60° in the case of the ideal model and in the case where thirty two antenna elements are arranged in the scanning direction and at 5 mm apart from the single glass;

FIG. 28 is a graph illustrating the gains of TE incidence at the target angles of 0°, 20°, 40°, and 60° in the case of the ideal model and in a case where thirty two antenna elements are arranged in the scanning direction and at 10 mm apart from the single glass;

FIG. 29 is a graph illustrating the gains of TM incidence at the target angles of 0°, 20°, 40°, and 60° in the case of the ideal model and in the case where thirty two antenna elements are arranged in the scanning direction and at 10 mm apart from the single glass;

FIG. 30 is a graph illustrating the gains of TE incidence at the target angles of 0°, 20°, 40°, and 60° in the case of the ideal model and in a case where thirty two antenna elements are arranged in the scanning direction and at 20 mm apart from the single glass;

FIG. 31 is a graph illustrating the gains of TM incidence at the target angles of 0°, 20°, 40°, and 60° in the case of the ideal model and in the case where thirty two antenna elements are arranged in the scanning direction and at 20 mm apart from the single glass;

FIG. 32 is a graph illustrating the gains of TE incidence at the target angles of 0°, 20°, 40°, and 60° in the case of the ideal model and in a case where thirty two antenna elements are arranged in the scanning direction and at 50 mm apart from the single glass;

FIG. 33 is a graph illustrating the gains of TM incidence at the target angles of 0°, 20°, 40°, and 60° in the case of the ideal model and in the case where thirty two antenna elements are arranged in the scanning direction and at 50 mm apart from the single glass;

FIG. 34 is a table illustrating correlation coefficients between the value in the real model and the value in the ideal model at each angle in a case where thirty two antenna elements are arranged at a distance apart from the single glass, the distance being 5, 10, 20, 30, 40, and 50 mm;

FIG. 35 is a cross-sectional view of an analysis model in which an antenna element is disposed apart from the insulated glass without a matching layer;

FIG. 36 is a diagram illustrating transmission characteristics for TE incidence in a real model with a matching layer and a real model without a matching layer;

FIG. 37 is a diagram illustrating transmission characteristics for TM incidence in the real model with the matching layer and the real model without the matching layer;

FIG. 38 is a graph illustrating the gains of TE incidence at the target angles of 0°, 10°, 20°, 30°, 40°, 50°, and 60° in the case where thirty two antenna elements are arranged in the scanning direction and at 20 mm apart from the insulated glass when there is a matching layer and when there is no matching layer;

FIG. 39 is a graph illustrating the gains of TM incidence at the target angles of 0°, 10°, 20°, 30°, 40°, 50°, and 60° in the case where thirty two antenna elements are arranged in the scanning direction and at 20 mm apart from the insulated glass when there is a matching layer and when there is no matching layer;

FIG. 40 is a diagram illustrating an ideal model which is a single-element infinite periodic analysis model constituted by a dipole antenna;

FIG. 41A is an overall perspective view of a real model in which multiple dipole antenna elements are arranged in the scanning direction and at a distance apart from the insulated glass when TE incidence is simulated;

FIG. 41B is an enlarged perspective view of a quadrilateral portion of the real model in FIG. 41A;

FIG. 41C is a top view illustrating positions of feed points on the dipole antenna included in the real model of FIG. 41A;

FIG. 42A is an overall perspective view of a real model in which multiple dipole antenna elements are arranged in the scanning direction and at a distance apart from the insulated glass when TM incidence is simulated;

FIG. 42B is an enlarged perspective view of a quadrilateral portion of the real model in FIG. 42A;

FIG. 42C is a top view illustrating positions of feed points on the dipole antenna included in the real model of FIG. 42A;

FIG. 43 is a graph illustrating the gains of TE incidence at target angles of 0°, 10°, 20°, 40°, and 60° in the case of the ideal model and in a case where thirty two dipole antenna elements are arranged in the scanning direction and at 20 mm apart from the insulated glass;

FIG. 44 is a graph illustrating the gains of TM incidence at the target angles of 0°, 10°, 20°, 40°, 50°, and 60° in the case of the ideal model and in the case where thirty two dipole antenna elements are arranged in the scanning direction and at 20 mm apart from the insulated glass;

FIG. 45 is a table illustrating correlation coefficients between the value in the real model and the value in the ideal model at each angle in a case where thirty two antenna elements are arranged at 20 mm apart from the insulated glass;

FIG. 46 is an explanatory diagram of analysis models in which array antenna elements are disposed at a distance apart from the insulated glass with the matching layer;

FIG. 47 is a table illustrating correlation coefficients between the value in the real model and the value in the ideal model at an angle of 40-degree direction in a case where a number of antenna elements is arranged at a distance apart from the insulated glass, the number of antenna elements being two, four, eight, sixteen, and thirty two, the distance being 5 mm, 10 mm, 20 mm, 30 mm, 40 mm, and 50 mm; and

FIG. 48 is a diagram explaining a recommended range of the antenna-window glass distance depending on the size of the array antenna.

### DESCRIPTION OF THE PREFERRED EMBODIMENT

In a case where an antenna for radiating radio waves to the outdoor side of window glass of a dielectric plate is disposed on the indoor side of the window glass, and the radio waves are radiated obliquely from the antenna, there is a possibility that the radiation characteristics of the antenna may be deteriorated depending on how the antenna is disposed due to the oblique incidence characteristic of the closely disposed window glass, the window glass itself, and unnecessary resonance caused by the window glass and the antenna.

The present disclosure provides an antenna device and window glass for a structure such as a house, a building, or a factory that can improve radiation characteristics of the antenna even in a case where the antenna is installed near the window glass.

According to an aspect of the present disclosure, radiation characteristics of an antenna even in a case where the antenna is installed near window glass can be improved.

Hereinafter, an embodiment will be described with reference to the drawings. For ease of understanding, the scale of each member in the drawings may be different from the actual scale. In directions such as parallel, right angle, orthogonal, horizontal, vertical, top-bottom, left-right, and the like, deviations are allowed to such an extent that the functions and effects of the embodiment are not impaired. The shape of the corner portion is not limited to a right angle and may be rounded in an arcuate shape. Parallel, perpendicular, orthogonal, horizontal, and vertical may include substantially parallel, substantially perpendicular, substantially orthogonal, substantially horizontal, and substantially vertical.

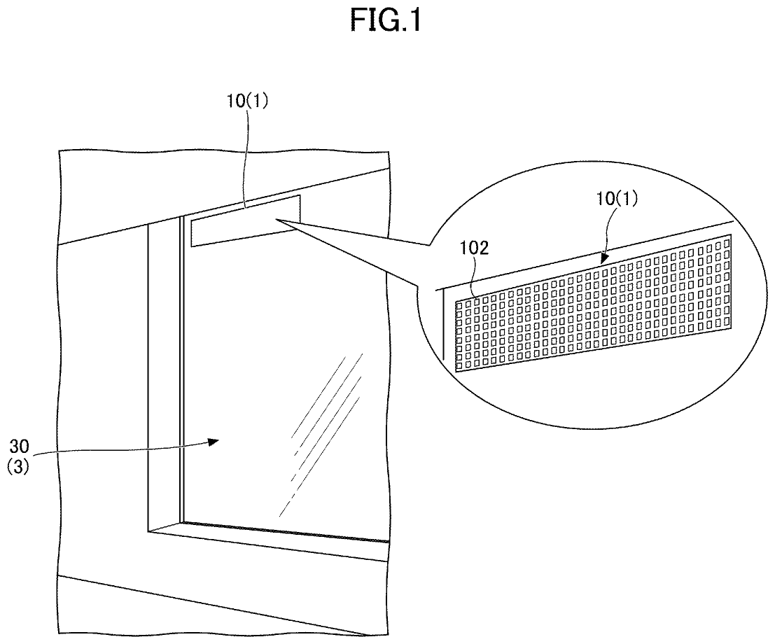

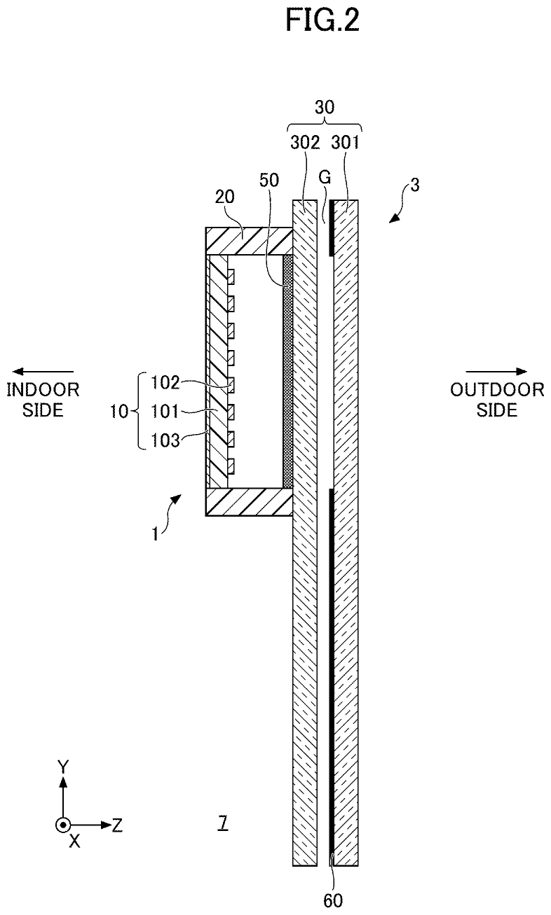

In this specification, a three dimensional orthogonal coordinate system having three axis directions (an X-axis direction, a Y-axis direction, and a Z-axis direction) is used, and the width direction of the window glass is defined as the X-axis direction, the height direction of the window glass is defined as the Y-axis direction, and the thickness direction of the window glass is defined as the Z-axis direction. The direction from the bottom to the top of the window glass is defined as the +Y-axis direction, and the opposite direction is defined as the −Y-axis direction. The direction from the indoor side to the outdoor side is defined as a +Z-axis direction, and the opposite direction is defined as a −Z-axis direction. In the following description of FIG. 1 and FIG. 2, the +Y-axis direction may be referred to as an upper direction and the −Y-axis direction may be referred to as a lower direction. The +Z-axis direction may be referred to as an outdoor side, and the −Z-axis direction may be referred to as an indoor side.

The X-axis direction, the Y-axis direction, and the Z-axis direction represent a direction parallel to the X-axis, a direction parallel to the Y-axis, and a direction parallel to the Z-axis, respectively. The X-axis direction, the Y-axis direction, and the Z-axis direction are orthogonal to each other. The XY plane, the YZ plane, and the ZX plane represent a virtual plane parallel to the X-axis direction and the Y-axis direction, a virtual plane parallel to the Y-axis direction and the Z-axis direction, and a virtual plane parallel to the Z-axis direction and the X-axis direction, respectively.

FIG. 1 is a diagram illustrating an indoor side arrangement example of an antenna device according to an embodiment of the present disclosure. In the example illustrated in FIG. 1, an array antenna 10 of an antenna device 1 is installed so as to face an indoor-side surface (first principal surface) of window glass 3 for a building and used.

The window glass 3 such as an insulated glass 30 is a glass plate used for window of a structure such as a house, a building, or a factory. The window glass has, for example, a quadrilateral shape in a front view of the glass surface thereof, and has a first glass surface and a second glass surface opposite from the first glass surface. The thickness of the window glass is set in accordance with required specification of the structure or the like. The first glass surface and the second glass surface may be referred to as a first principal surface and a second principal surface, respectively. In the present embodiment, the quadrilateral shape includes a rectangle, a square as well as shapes obtained by chamfering corners of a rectangle and a square. The shape of the window glass in a front view is not limited to a quadrilateral shape and may be another shape such as a circular shape.

In the example illustrated in FIG. 1, the antenna device 1 is an element used by being attached to the indoor side of the building window glass 3, and transmits and receives radio waves in a high-frequency band (for example, 0.3 GHz to 300 GHz) such as microwaves including millimeter waves through the window glass 3.

The antenna device 1 is formed to be capable of transmitting and receiving radio waves corresponding to, for example, a fifth generation mobile communication system (so-called 5G), a wireless communication standard such as Bluetooth®, or a wireless local area network (LAN) standard such as IEEE802.11ac. Note that the antenna device 1 may be formed to be able to transmit and receive electromagnetic waves corresponding to standards other than these above-mentioned standards, or may be formed to be able to transmit and receive electromagnetic waves of different frequencies. Furthermore, the antenna device 1 can be used as, for example, a radio base station that is used facing the window glass 3.

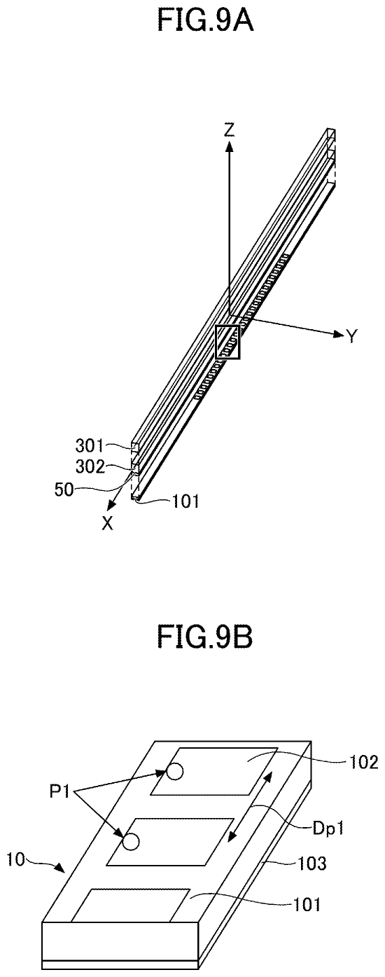

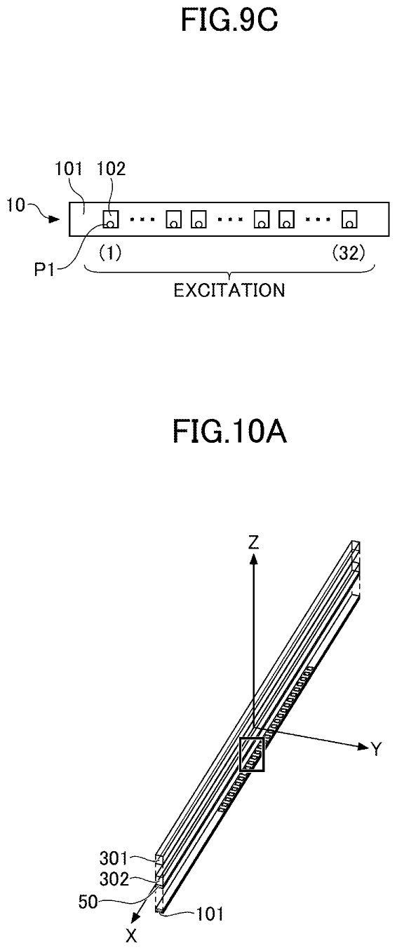

As illustrated in an enlarged view of FIG. 1, multiple radiating elements 102 are arranged in an array in the array antenna 10 of the antenna device 1. In the present embodiment, it is preferable that at least four radiating elements (also referred to as antenna elements) 102 are provided in the beam scanning direction. The number and characteristics of the radiating elements in the array antenna will be described later from FIG. 9A onwards.

As illustrated in FIG. 1, the antenna device 1 is disposed so as to face the window glass 3 installed to a building. Since the antenna device 1 faces the window glass 3 installed to the building, the beam can be transmitted from a relatively high position toward the ground, and the beam can also be easily transmitted while avoiding an obstacle existing between the window glass and the ground. Accordingly, the antenna device 1 can form a communication area in which a relatively high throughput can be obtained between the antenna device and the ground.

Furthermore, in the example illustrated in FIG. 1, the antenna device 1 is installed on the indoor side of the building with respect to the window glass 3. Thus, the installation of the antenna device 1 can be performed by indoor construction, and the installation work is facilitated.

As illustrated in FIG. 1, the antenna device 1 is preferably provided at a high position on the window glass 3. Note that the height of the antenna device 1 is defined as a height from a reference plane (for example, the ground, the floor, or a virtual plane) parallel to a horizontal plane.

FIG. 2 is a cross-sectional diagram schematically illustrating an example of a laminated configuration of window glass with the antenna device according to the embodiment of the present disclosure. An antenna device attached window glass 7, which is building window glass, includes the antenna device 1 and the window glass 3. The antenna device 1 is attached to the indoor-side surface of the building window glass 3.

For example, the X-axis direction and the Z-axis direction illustrated in FIG. 2 are substantially parallel to a direction parallel to the horizontal plane (horizontal direction), and a Y-axis direction is substantially parallel to a vertical direction perpendicular to the horizontal plane.

The antenna device 1 includes the array antenna 10 and a support part 20. The array antenna 10 radiates radio waves in a predetermined frequency band to the outdoor side of the window glass 3, and is installed on the indoor side without contacting the window glass 3.

The array antenna 10 according to the embodiment illustrated in FIG. 2 includes an antenna substrate 101, the radiating elements 102, and a ground layer 103.

As illustrated in the enlarged view of FIG. 1 and FIG. 2, the array antenna 10 has at least four radiating elements 102 arranged substantially parallel to the window glass 3 and substantially parallel to a beam scanning plane of the radio waves. Note that the beam scanning plane refers to a plane in a changing direction of a variable beam radiated from the antenna.

The radiating element 102 is an antenna conductor formed to be capable of transmitting and receiving radio waves in a desired frequency band. Examples of the desired frequency band include an ultra high frequency (UHF) band having a frequency of 0.3 to 3 GHz, a super high frequency (SHF) band having a frequency of 3 to 30 GHz, and an extremely high frequency (EHF) band having a frequency of 30 to 300 GHz. The radiating element 102 functions as a radiator.

The antenna substrate 101 is provided so as to be located on the indoor side with respect to the radiating element 102. The ground layer 103 is provided so as to be located on the indoor side with respect to the antenna substrate 101.

Specifically, the array antenna 10 according to the present embodiment has a configuration in which the antenna substrate 101, which is a dielectric member, is interposed between the radiating element 102 and the ground layer 103 so that a microstrip antenna, which is a type of planar antenna, is formed. The array antenna 10 is formed by arranging the radiating elements 102 on the surface of the antenna substrate 101 on the window glass 3 side.

The antenna substrate 101 is a dielectric member and is, for example, a dielectric substrate containing a dielectric as a main component. The antenna substrate 101 may be a member in a form different from the substrate (for example, a film). Specific examples of the antenna substrate 101 include substrates made of glass, acrylic, polycarbonate, polyvinyl butyral (PVB), cycloolefin polymer (COP), polyethylene terephthalate (PET), polyimide, ceramic, and sapphire. In a case where the antenna substrate 101 is formed using a glass substrate, examples of the material of the glass substrate include alkali-free glass, quartz glass, soda lime glass, borosilicate glass, alkali borosilicate glass, and aluminosilicate glass.

The radiating element 102 is a conductor formed in a planar shape on the outdoor side surface of the antenna substrate 101. The radiating element 102 is formed of a conductive material such as gold (Au), silver (Ag), copper (Cu), aluminum (Al), chromium (Cr), lead (Pd), zinc (Zn), nickel (Ni), or platinum (Pt). The conductive material may be an alloy, for example, such as an alloy (brass) of copper and zinc, an alloy of silver and copper, or an alloy of silver and aluminum. The radiating element 102 may be a thin film. The shape of the radiating element 102 may be quadrilateral, circular, or linear, but is not limited to these shapes.

The radiating element 102 is fed by a feed point that uses the ground layer 103 as a ground reference. As the radiating element 102, for example, a patch element or a dipole element can be used.

The ground layer (also referred to as a ground conductor or a waveguide member) 103 is a conductor formed in a planar shape on the indoor-side surface of the antenna substrate 101. The ground layer 103 is formed of a conductive material such as gold (Au), silver (Ag), copper (Cu), aluminum (Al), chromium (Cr), lead (Pd), zinc (Zn), nickel (Ni), or platinum (Pt). The conductive material may be an alloy, for example, such as an alloy (brass) of copper and zinc, an alloy of silver and copper, or an alloy of silver and aluminum. Alternatively, the ground layer 103 may be formed by bonding a conductive material to, for example, a glass substrate or a resin substrate. The ground layer 103 may also be a thin film.

The conductor used for the radiating element 102 and the ground layer 103 may be formed in a mesh state in order to have optical transparency. Here, the mesh refers to a state in which net-like through holes are opened in a plane of a conductor.

When the conductor is formed in a mesh state, the mesh opening may have a square shape or a diamond shape. Alternatively, it may have a honeycomb shape such as a hexagonal shape, or may have any shape. In a case where the mesh opening is formed in a quadrilateral shape, the mesh opening is preferably square. The mesh with square shaped openings is good in design. Alternatively, the mesh may also have random shaped openings formed by a self-assembly method. The random shape can prevent moire to some extent. The line width of the mesh is preferably 5 to 30 μm, and more preferably 6 to 15 μm. The line interval of the mesh is preferably 50 to 500 μm, and more preferably 100 to 300 μm. Assuming the wavelength in the air at the operating frequency of the radiating element 102 is λ₀, the line interval of the mesh is preferably less than or equal to 0.5 λ₀, more preferably less than or equal to 0.1 λ₀, and still more preferably less than or equal to 0.01 λ₀. The performance of the antenna is high while the line interval of the mesh is less than or equal to 0.5 λ₀. Furthermore, the line interval of the mesh may be greater than or equal to 0.001 λ₀.

The support part 20 supports the array antenna 10 with respect to the window glass 3. In the present embodiment, the support part 20 supports the array antenna 10 such that a space is formed between the window glass 3 and the radiating element 102 of the array antenna 10. The support part 20 may be a spacer that secures the space between the window glass 3 and the array antenna 10, or may be a housing of the array antenna 10.

The support part 20 is formed of a dielectric base material. As the material of the support part 20, for example, a known resin such as a silicone resin, a polysulfide resin, or an acrylic resin can be used. A metal such as aluminum may also be used for the material.

FIG. 2 illustrates an example in which the window glass 3 is the insulated glass 30 in which two glass plates 301 and 302 are disposed to face each other with a space G therebetween. Note that the window glass 3 in the present disclosure is not limited to an insulated glass having two glass plates, and may be a single glass (a single glass plate) or an insulated glass having three or more glass plates. Note that a single glass may be referred to as a single-layered glass.

Furthermore, the window glass 3 may be low-e glass, light control glass, or linear member containing glass. Low-e glass is also referred to as low-emissivity glass, and a coating layer (transparent conductive film) 60 having a function of reflecting heat rays is coated on the indoor-side surface of a glass plate 301 on the outdoor side of the window glass. In such a case, the transparent conductive film 60 may have an opening in order to suppress a decrease in radio wave transmission performance. As illustrated in FIG. 2, the opening of the transparent conductive film 60 is preferably located at a position facing at least a part of the radiating elements 102 which will be described later. Alternatively, patterning may be performed on the opening of the transparent conductive film 60. In the patterning, for example, the coating layer is removed in a lattice shape so that rectangular coating layers are arranged and left. Patterning may be performed on only a part of openings. Furthermore, in the linear member containing glass, the linear member such as metal is disposed inside the glass. The linear member may have a mesh shape, and the linear member containing glass is also referred to as meshed glass.

Examples of the material of the glass plates 301 and 302 constituting the window glass 3 include, for example, soda lime silica glass, borosilicate glass, aluminosilicate glass, and alkali-free glass.

As illustrated in FIG. 2, in a case where the window glass 3 is constituted by the insulated glass 30, the thicknesses of the glass plate 301/the space G/the glass plate 302 may be, for example, 6 mm/12 mm/6 mm or 6 mm/6 mm/6 mm, which are common in Japan, or 6 mm/12.7 mm/6 mm, which is common in the

United States. In Japan, the insulated glass 30 is often a combination of glass plates having respective thicknesses of 5 to 10 mm and a space G having a thickness of 6 to 12 mm. The glass plate has sufficient strength for attaching the antenna device 1 if the thickness of the glass plate 302 on the indoor side of the window glass 3 is greater than or equal to 1.0 mm.

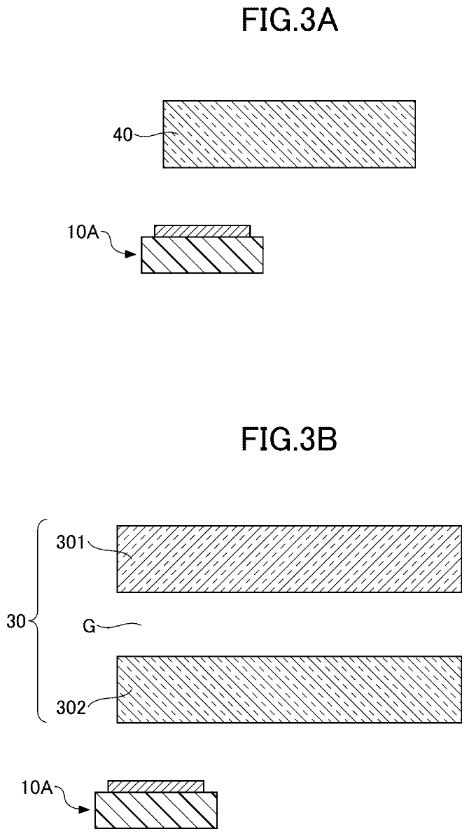

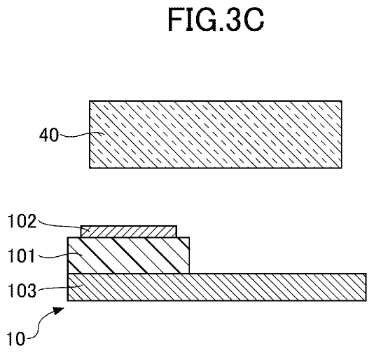

Alternatively, in a case where the window glass 3 is a glass constituted by a single glass 40 (see FIG. 3A), the thickness of one glass plate of the single glass is preferably 1.0 to 20 mm by itself. The single glass 40 has sufficient strength for attaching the antenna device 1 if the thickness of the glass plate of the single glass is greater than or equal to 1.0 mm. The single glass 40 also has sufficient radio wave transmission performance if the thickness of the single glass is less than or equal to 20 mm. The thickness of the single glass 40 is preferably 3.0 to 15 mm, and more preferably 9.0 to 13 mm.

Furthermore, in the present embodiment, a matching layer 50 is provided on the indoor side of the insulated glass 30.

The matching layer 50 is a medium between the radiating element 102 and the glass plate 302, and it is preferable that the matching layer 50 has properties more similar to those of the radiating element 102 than those of the glass plate 301. For example, the matching layer 50 is a dielectric layer which is a dielectric base material containing, as a main component, a dielectric having a relative dielectric constant Dk of greater than 1 and less than or equal to 15 (preferably less than or equal to 7, more preferably less than or equal to 5, particularly preferably less than or equal to 2.2).

As the matching layer 50, for example, fluororesin, cycloolefin copolymer (COC), cycloolefin polymer (COP), polyethylene terephthalate (PET), polyimide, ceramic, sapphire, or a glass substrate can be used. In a case where the matching layer 50 is formed of a glass substrate, examples of the material of the glass substrate include alkali-free glass, quartz glass, soda lime glass, borosilicate glass, alkali borosilicate glass, and aluminosilicate glass. The dielectric constant is measured by, for example, a cavity resonator.

### Radio Wave Interference

Here, interference of radio waves generated when an antenna is disposed close to window glass will be described with reference to FIG. 3A to 3C. FIG. 3A to FIG. 3C are schematic diagrams explaining radio wave interference due to the oblique incidence characteristic of the window glass and unnecessary resonance between the window glass and the antenna. FIG. 3A is a diagram schematically illustrating a case where a single glass is present close to the antenna, FIG. 3B is a diagram schematically illustrating a case where the insulated glass is present close to the antenna, and FIG. 3C is a diagram schematically illustrating a case where a single glass is present close to the antenna having the ground layer.

In a case where there is a dielectric such as window glass close to the antenna as illustrated in FIG. 3A to FIG. 3C, reflection occurs at the dielectric interface and the antenna characteristics deteriorate. The ground layer 103 of the antenna also becomes a factor that deteriorates the performance.

Accordingly, the inventors of the present disclosure have found that there is a relationship between the number of radiating elements and antenna performance deterioration in a case where the radio waves are radiated obliquely from the antenna. Hereinafter, description will be made using examples.

### EXAMPLES

The inventors of the present disclosure created an ideal model and analysis models (real models) under different conditions, and compared and studied a radiation gain of the antenna in each model.

### Example 1: Characteristic Simulation of Single Element

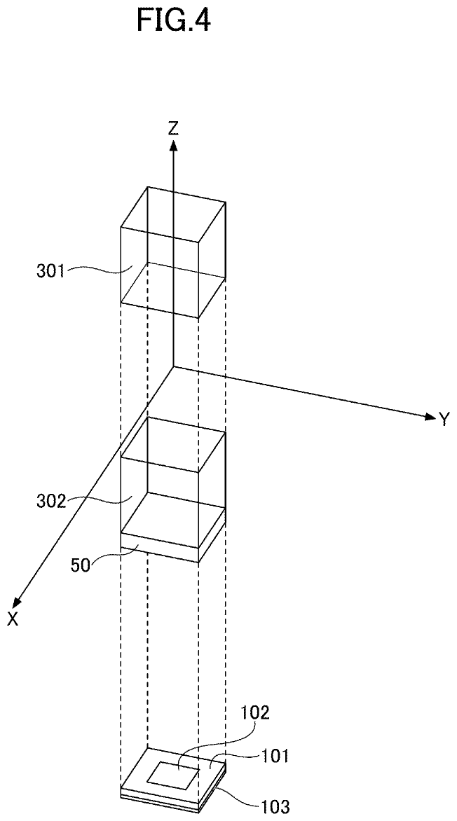

FIG. 4 is a diagram illustrating an ideal model, which is a single-element infinite periodic analysis model, including one radiating element (hereinafter, also referred to as an antenna element) constituted by a patch antenna. An ideal model A illustrated in FIG. 4 is the single-element infinite periodic analysis model and is a model with a single gain and array factor (AF) in which a periodic boundary condition is set in the Y direction and a radial boundary condition is set in the Z direction. The array factor is given by Equation 1. In Equation 1, wᵢ is a complex weight coefficient for ith element, the amplitude of the input signal of each element is constant, and the phase of the input signal of each element is adjusted to control the beam in a desired direction. Hereinafter, in the analysis models of FIG. 4 to FIG. 45, unlike FIG. 1 and FIG. 2 described above, the +Z-axis direction which is the outdoor direction may be referred to as an upper direction, and the −Z-axis direction which is the indoor direction may be referred to as a lower direction.

$$\begin{matrix}AF ( θ , φ ) = {\sum }_{i = 1}^{n} {w}_{i} exp ( {jk}_{0} \hat{r} \cdot {r}_{i} ) \\ = {\sum }_{i = 1}^{n} {w}_{i} exp ( {jk}_{0} ( sin θ ( {x}_{i} cos φ + {y}_{i} sin φ ) + {z}_{i} cos θ ) )\end{matrix} \qquad Equation 1$$

where,
wᵢ: complex weight coefficient for ith element,
rᵢ=xᵢ\hat{x}+yᵢŷ+zᵢ\hat{z}: position of ith element, and

$${k}_{0} = \frac{2 π}{λ} :$$

tree-space wave number

That is, the ideal model A is a model obtained by simulating element directivity (element characteristics) in the single-element infinite periodic analysis model in a configuration in which antenna elements are disposed under glasses and a matching layer. The element directivity (element characteristic) is simulated by arranging N antenna elements and dividing by N, and in this model, it corresponds to a case in which N is infinitely increased. Since this model is an ideal model, the deterioration illustrated in FIG. 3A to FIG. 3C does not appreciably occur.

The model size of the ideal model A illustrated in FIG. 4 is as follows:
X direction: 5.4 mm;
Y direction: 5.4 mm; and
Z direction: 64 mm.

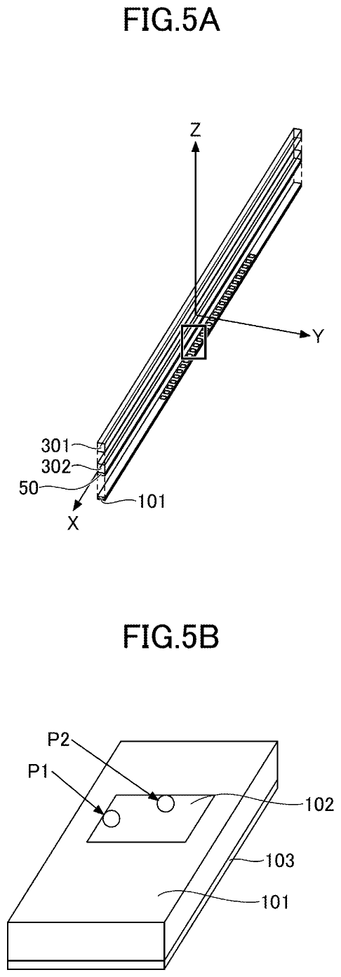

FIG. 5A and FIG. 5B are diagrams illustrating a real model B in a case where an insulated glass is disposed close to one antenna element constituted by a patch antenna. The real model B illustrated in the FIG. 5A is an analysis model of a periodic boundary for elements, and is a real model in which a periodic boundary condition is set in the Y direction, a radiation boundary condition in which a finite number of antenna elements are arranged with a constant distance is set in the X direction, and a radiation boundary condition is set in the Z direction (upper surface). The real model is obtained by simulating one element with a physical size. For the simulation, a commercially available electromagnetic field simulator ANSYS® HFSS was used. In the analysis model (real model) in FIG. 5A, a multi-element model is used, but only one element is excited and the other elements are terminated to derive the characteristics of only one antenna element. FIG. 5B is an enlarged perspective view of a quadrilateral portion of the real model B in FIG. 5A illustrating the antenna element to be excited and feed points.

The model size of the real model B illustrated in FIG. 5A is as follows:
X direction: 420 mm;
Y direction: 5.4 mm; and
Z direction: 64 mm.

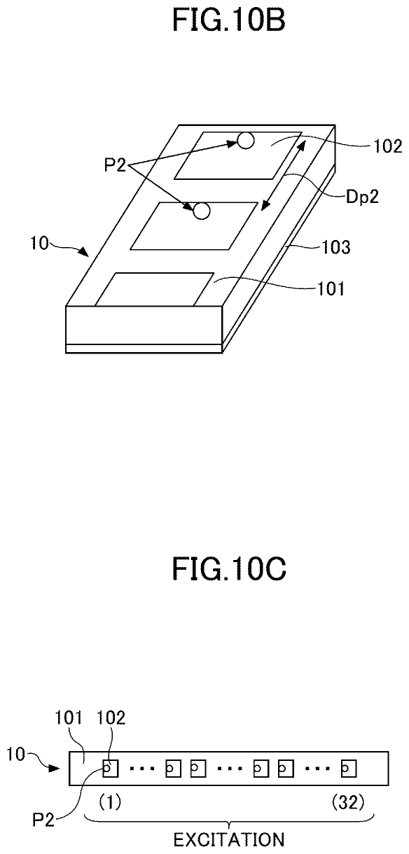

The size of the real model B is the same as that of a model having thirty two elements illustrated in FIG. 9A to FIG. 10C which will be described later. Furthermore, the real model B in FIG. 5A has a sufficiently long length for analysis in the X direction so that, in a case where radio waves are radiated obliquely from the antenna in the X direction, characteristics including the influence of the oblique incidence characteristic when the radio waves are incident at various angles can be analyzed.

In the real model B, as illustrated in FIG. 5B, feed points P1 and P2 are provided in the radiating element 102 which is a square patch element (patch antenna element). The feed point P1 is provided at the center in the X direction and on the end side in the −Y direction to radiate a transverse electric wave (TE wave) in which the electric field is orthogonal to the plane of incidence (XZ plane) on the glass. The feed point P2 is provided at the center in the Y direction and on the end side in the −X direction to radiate a transverse magnetic wave (TM wave) in which the magnetic field is orthogonal to the plane of incidence (XZ plane) on the glass.

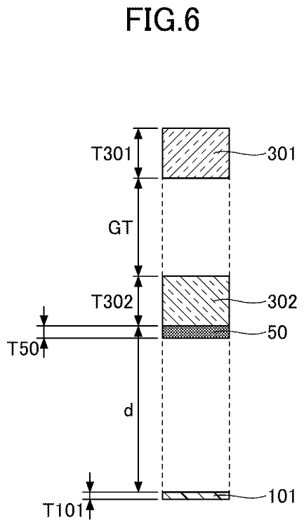

FIG. 6 is a cross-sectional view of analysis models (ideal model A, real model B) in which the antenna element is disposed apart from the insulated glass with the matching layer which is illustrated in FIG. 4 and FIG. 5.

Here, assuming that the thickness of the glass plate 301 is T301, the thickness of the glass plate 302 is T302, the thickness of the matching layer 50 is T50, the distance of a gap G between the two glass plates is GT, the distance between the glass plate 302 and the antenna substrate is d, and the thickness of the antenna substrate 101 is T101, then T301: 6 mm, GT: 12 mm, T302: 6 mm, T50: 1 mm, d: 20 mm, and T101: 1 mm.

Note that the insulated glass having T301: 6 mm, GT: 12 mm, and T302: 6 mm has dimensions similar to those of commonly distributed insulated glass.

The glass plates 301 and 302 have a relative dielectric constant Dk of 6.5 and a dissipation factor Df of 0.013. The matching layer 50 has a relative dielectric constant Dk of 2.77 and a dissipation factor Df of 0.006.

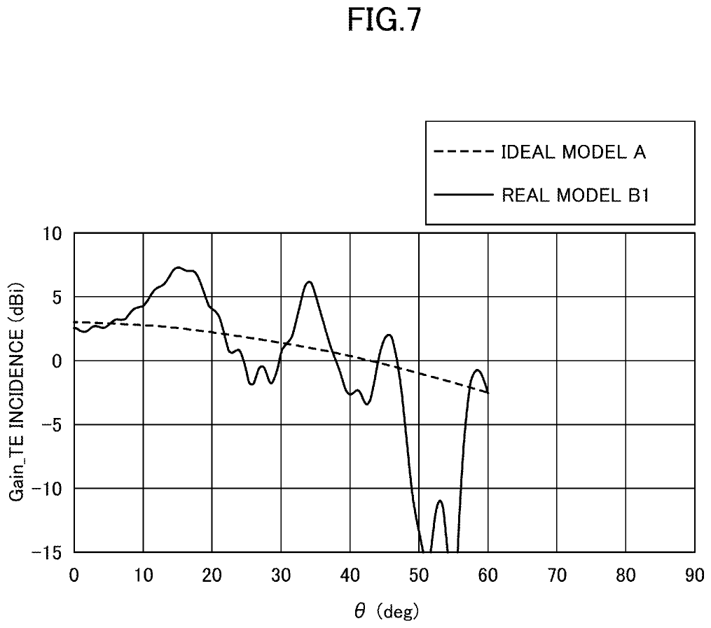

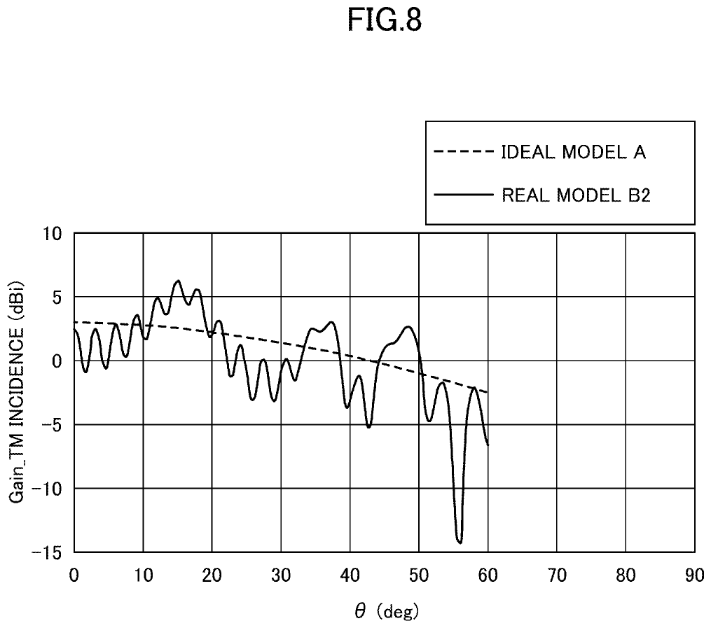

Here, for the ideal model A of the single-element infinite periodic analysis model illustrated in FIG. 4 and the real model B in which a single radiating element is excited illustrated in FIG. 5B, the characteristics in the case where radiation is performed directly upward from the antenna were compared. In such a simulation, the frequency of the radio waves radiated from the antenna was 28 GHz. FIG. 7 is a graph illustrating the gains of TE incidence in the ideal model A of FIG. 4 and the real model B in FIG. 5B. FIG. 8 is a graph illustrating the gains of TM incidence in the ideal model A of FIG. 4 and the real model B in FIG. 5B.

For both TE incidence in FIG. 7 and TM incidence in FIG. 8, the gain of the ideal model A indicated by a broken line has a clear waveform without a large drop in gain at all angles.

For both TE incidence and TM incidence, each gain of the real model B, which is obtained by simulating one actual element, indicated by a solid line has a waveform including large and small dips (ripples and nulls).

Such a difference in characteristics is caused by deterioration due to interference of an oblique incidence characteristic when radio waves are passed through window glass illustrated in FIG. 3B and deterioration due to unwanted mode interference between the window glass and the ground layer illustrated FIG. 3C. Specifically, the large wave of the waveform of the solid line in the gain of the real model B is caused by the oblique incidence characteristic due to the interference of radio waves between the glass principal surfaces of the insulated glass 30, and the small ripples are caused by the unnecessary resonance between the insulated glass 30 and the ground layer 103.

Here, the inventors of the present disclosure have found that, by increasing the number of radiating elements in the antenna, deterioration due to interference of the oblique incidence characteristic when radio waves obliquely radiated from the antenna are passed through the window glass and deterioration due to unwanted mode interference between the window glass and the ground layer are reduced. This phenomenon will be described in Example 2.

### Example 2: Simulation of Insulated Glass with Different Numbers of Antenna Elements

First, in an analysis model (real model) under the same conditions such as the dimensions of members, the number of radiating elements to be excited was changed to simulate characteristics of the antenna as illustrated in FIG. 9A to FIG. 15 below.

FIG. 9A to FIG. 9C are diagrams illustrating a real model Ce in which thirty two antenna elements are arranged in the scanning direction and at a distance apart from the insulated glass when TE incidence is simulated. FIG. 9A illustrates a perspective view of the real model Ce, FIG. 9B illustrates an enlarged perspective view of a quadrilateral portion in FIG. 9A, and FIG. 9C illustrates a top view illustrating positions of feed points on the array antenna 10 included in the real model Ce.

In the real model Ce, as illustrated in FIG. 9C, a feed point P1 is provided at the center in the X direction and on the end side in the −Y direction in each of the multiple radiating elements 102 of square patch elements to radiate a TE wave.

FIG. 10A to FIG. 10C are diagrams illustrating a real model Cm in which thirty two antenna elements are arranged in the scanning direction and at a distance apart from the insulated glass when TM incidence is simulated. FIG. 10A illustrates a perspective view of the real model Cm, FIG. 10B illustrates an enlarged perspective view of a quadrilateral portion in FIG. 10A, and FIG. 10C illustrates a top view illustrating positions of feed points on the array antenna 10 included in the real model Cm.

In the real model Cm, as illustrated in FIG. 10C, a feed point P2 is provided at the center in the Y direction and on the end side in the −X direction in each of the multiple radiating elements 102 of square patch elements to radiate a TM wave.

Note that a distance Dp1 between the feed points P1 illustrated in FIG. 9C and a distance Dp2 between the feed points P2 illustrated in FIG. 10C were 5.4 mm. The distances Dp1 and Dp2 between the feed points may be any distance less than the half-wavelength of the radio wave to be radiated. The distance between the feed points 5.4 mm is a length corresponding to less than a half-wavelength of 28 GHz which is the frequency used in the simulation.

Each of real models C32e and C32m illustrated in FIG. 9A to FIG. 10C is an analysis model of a periodic boundary for elements, and is a real model with a side surface to be set as a periodic boundary and the top surface to be set as the radiation direction. The model size is as follows: X direction: 420 mm, Y direction: 5.4 mm, and Z direction: 64 mm.

In the real models C32e and C32m illustrated in FIG. 9A to FIG. 10C, the dimensions of the respective parts are the same as those of the real model B. The glass plates 301 and 302 have a relative dielectric constant Dk of 6.5 and a dissipation factor Df of 0.013, and the matching layer 50 has a relative dielectric constant Dk of 2.77 and a dissipation factor Df of 0.006, which are the same as those of the real model B.

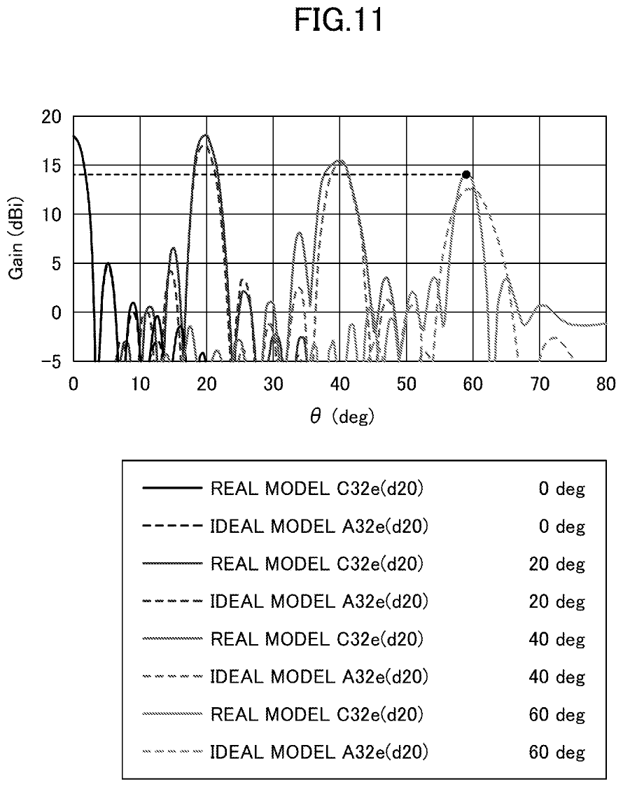

FIG. 11 to FIG. 17 illustrate simulation results of the gains of TE incidence and TM incidence at target angles of 0°, 20°, 40°, and 60° by changing the number of radiating elements to be fed.

Here, in an array antenna including multiple radiating elements, a beam direction (also referred to as a target angle or a target direction) can be changed by changing an excitation phase with respect to a feed point.

In the real models C32e and C32m in FIG. 9A, and in FIG. 10A, the X direction is an angular direction of inclination when radio waves are radiated. Therefore, the beam forming direction includes the target angle 0° which is the Z direction directly above, the target angle 20° which is the direction shifted by 20° from directly above in the X direction, the target angle 40° which is the direction shifted by 40° from directly above in the X direction, and the target angle 60° which is the direction shifted by 60° from directly above in the X direction.

The length in the X direction, which is the beam scanning direction of the variable beam in the real models C32e and C32m, is sufficiently longer than the lengths in the Y direction and the Z direction in order to radiate the beam in the region where the window glass (the glass plates 301 and 302) exists, when the antenna radiates the beam at the target angle of 60°.

For each analysis model described below, multiple beam directions (target angles) were set and the gains were simulated.

### Case of Thirty Two Elements

First, based on the analysis results of TE incidence and TM incidence with one element of the ideal model A which is the single-element infinite periodic analysis model illustrated in FIG. 4, the antenna characteristics (radiation gains) of ideal models A32e and A32m were simulated by using a theoretical formula, in the case where thirty two elements are arranged.

In the real model C32e having thirty two radiating elements in FIG. 9A to FIG. 9C, radiation gains at a frequency of 28 GHz when TE incidence was performed by feeding and exciting all thirty two feed points P1 were simulated. FIG. 11 is a graph illustrating the gains of TE incidence at the target angles of 0°, 20°, 40°, and 60° in the case of the ideal model A32e (d20) and in the case where thirty two antenna elements are arranged in the scanning direction and at 20 mm apart from the insulated glass.

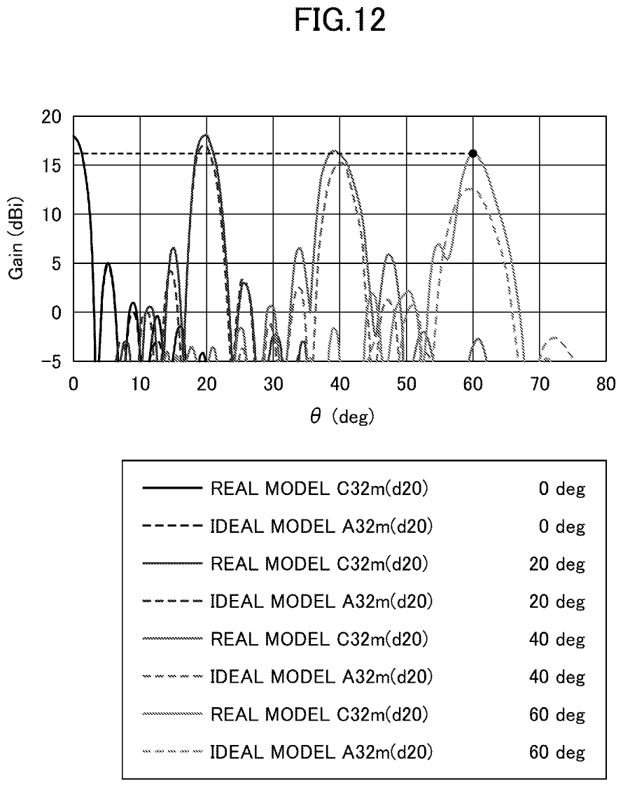

In the real model C32m having thirty two radiating elements in FIG. 10A to FIG. 10C, radiation gains at a frequency of 28 GHz when TM incidence was performed by feeding and exciting all thirty two feed points P2 were simulated. FIG. 12 is a graph illustrating the gains of TM incidence at the target angles of 0°, 20°, 40°, and 60° in the case of the ideal model A32m (d20) and in the case where thirty two antenna elements are arranged in the scanning direction and at 20 mm apart from the insulated glass.

Among the radiation gains of the ideal models A32e and A32m having thirty two elements indicated by the broken line in FIG. 11 and FIG. 12, the radiation gains with the target angles of 0°, 20°, 40°, and 60° have the largest mountain-shaped waveforms as maximum values (peaks) at positions close to the respective target angles of 0°, 20°, 40°, and 60°. Furthermore, in the radiation gain at each target angle, a waveform in which small mountain-shaped waveforms having peaks less than half of the largest mountain-shaped waveform are present on both sides of the largest mountain-shaped waveform is obtained.

The gain waveforms of the real models C32e and C32m indicated by the solid line in FIG. 11 and FIG. 12 have mountain-shaped maximum values (peaks) at positions close to the target angles of 0°, 20°, 40°, and 60°, and have waveform shapes similar to the gain waveforms of the ideal models A32e and A32m indicated by the broken line. That is, it is illustrated that the radiation gain for each angle tends to be similar between the ideal model A32e having infinite periods and the real model C32e and between the ideal model A32m and the real model C32m.

In the gain waveforms of the real models C32e and C32m indicated by the solid line, each peak of the beam at the target angle of 60° is, however, split into peaks unlike the respective ideal models A32e and A32m indicated by the broken line. Here, the peak gain of the largest peak among the split peaks at the target angle of 60° in the real model C32e is 14 dBi for TE incidence, and the peak gain in the real model C32m is 16 dBi for TM incidence.

### Case of Two Elements

Here, in the array antenna, substantially the same behavior is exhibited in a case where two of three or more antenna elements are excited and in a case where two antenna elements are arranged and excited. As recreation of the situation in a case where the number of antenna elements is changed, in real models C32e and C32m having thirty two radiating elements in FIG. 9A to FIG. 10C, power was fed to the feed points of two (four, eight, and sixteen) radiating elements in the center to excite the elements, thereby simulating the case where two (four, eight, and sixteen) antenna elements are arranged in the antenna.

In the real model C32e having thirty two radiating elements in FIG. 9A to FIG. 9C, power was supplied to the feed points P1 of two radiating elements 102 at the center to excite the elements, and a real model C2e was obtained. Radiation gains at a frequency of 28 GHz when TE incidence was performed were then simulated. Furthermore, in the real model C32m having thirty two radiating elements in FIG. 10A to FIG. 10C, power was supplied to the feed points P2 of two radiating elements at the center to excite the elements, and a real model C2m was obtained. Radiation gains at frequency of 28 GHz when TM incidence was performed were then simulated.

Furthermore, based on the analysis results of TE incidence and TM incidence with one element of the ideal model A which is the single-element infinite periodic analysis model illustrated in FIG. 4, the antenna characteristics of ideal models A2e and A2m by using the theoretical formula were simulated, in the case where two elements are arranged.

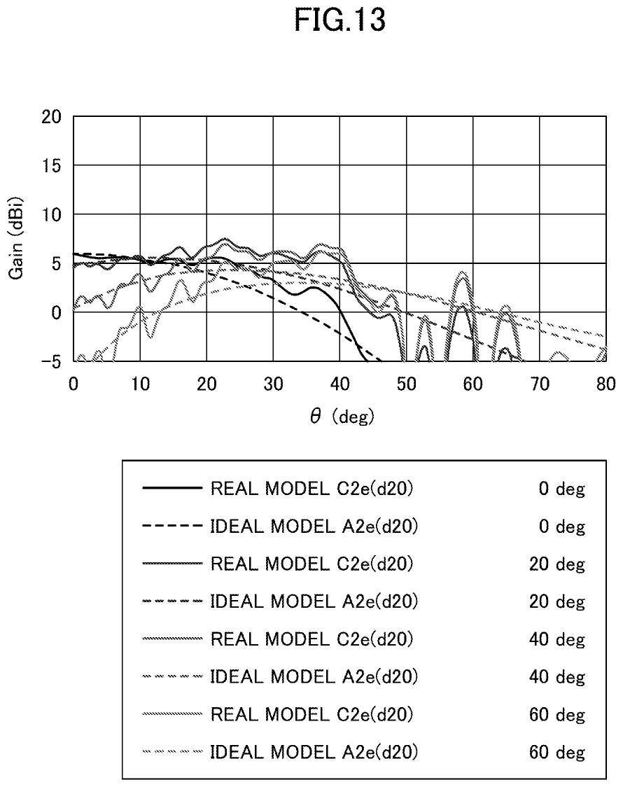

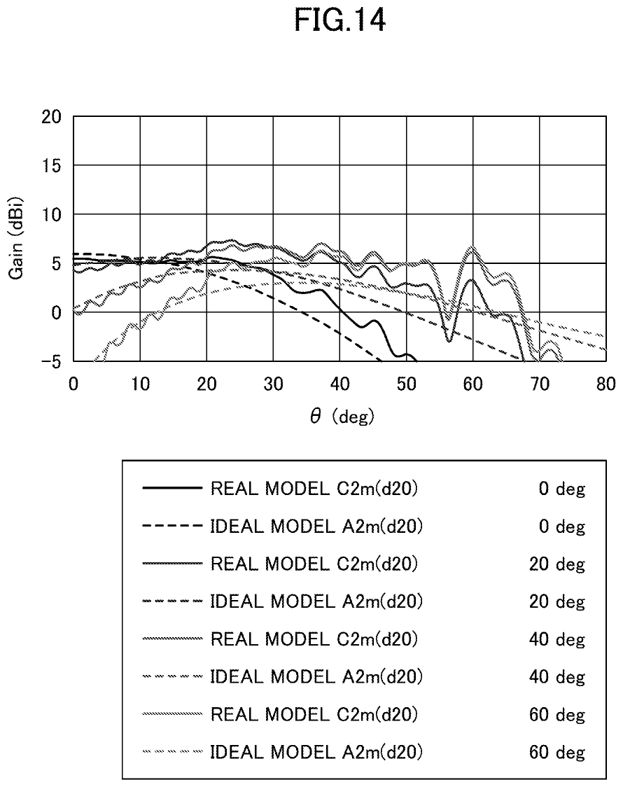

FIG. 13 is a graph illustrating the gains of TE incidence at the target angles of 0°, 20°, 40°, and 60° in the case of the ideal model A2e (d20) and in the case where two antenna elements are arranged in the scanning direction and at 20 mm apart from the insulated glass. FIG. 14 is a graph illustrating the gains of TM incidence at the target angles of 0°, 20°, 40°, and 60° in the case of the ideal model A2m (d20) and in the case where two antenna elements are arranged in the scanning direction and at 20 mm apart from the insulated glass.

In the waveforms of the radiation gains of two elements in FIG. 13 and FIG. 14, unlike the waveforms of thirty two elements illustrated in FIG. 11 and FIG. 12, a gentle waveform without a peak or a valley even for radiation at the target angles of 0°, 20°, 40°, and 60°, that is, a waveform in which the beam does not appreciably fluctuate, is obtained for each of the ideal models A2e and A2m illustrated by the broken line.

On the other hand, in the waveform of the radiation gain of each real models C2e and C2m indicated by the solid line in FIG. 13 and FIG. 14, a large peak does not appear at each of the target angles of 0°, 20°, 40°, and 60°, however, multiple peaks appear at angles unrelated to the target angles, and a waveform in which maximum values and minimum values for each peak are repeated is obtained.

As described above, in FIG. 13 and FIG. 14, when the gain waveforms of the ideal models A2e and A2m indicated by the broken line and the gain waveforms of the real models C2e and C2m indicated by the solid line are compared to each other, the waveform shapes indicated by the solid line are different from the shapes indicated by the broken line, and the shapes are not even similar to each other. Furthermore, in both the ideal models A2e and A2m and the real models C2e and C2m, there are no maximum values (peaks) at positions close to the target angles of 0°, 20°, 40°, and 60°. That is, in the configuration having two antenna elements, in both the ideal models and the real models, no beam has been formed in the target directions for both TE incidence and TM incidence.

### Correlation for Each Number of Elements

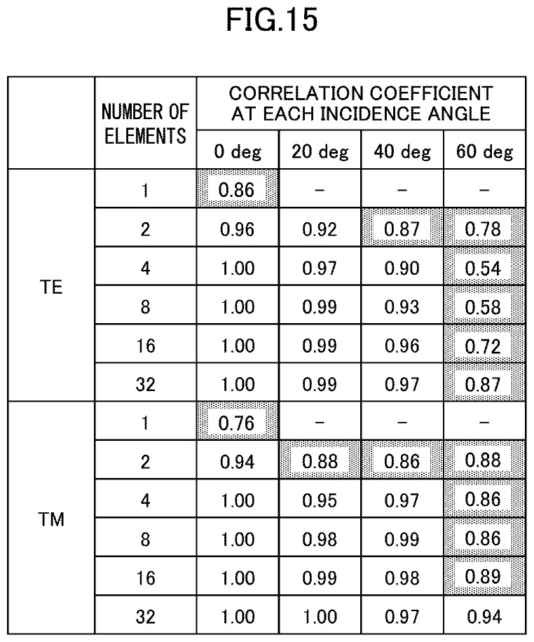

FIG. 15 is a table illustrating correlation coefficients between the gain value in the real model and the gain value in the ideal model at each angle in a case where a number of antenna elements is arranged at 20 mm apart from the insulated glass, the number of antenna elements being one, two, four, eight, sixteen, and thirty two. Although not illustrated in the graph, in addition to excitation by feeding to the above-described two and thirty two feed points, the inventors of the present disclosure performed excitation by feeding to one, four, eight, and sixteen feed points in the real models C32e and C32m having thirty two radiating elements in FIG. 9A to FIG. 10C to simulate the radiation gains at a frequency of 28 GHz for TM incidence and TE incidence at the target angles of 0°, 20°, 40°, and 60°.

Here, for each number of elements, the correlation coefficient between the value in the real model and the value in the ideal model at each angle in FIG. 15 was calculated in increments of 0.5° in a range of 0° to 90° using Equation (2).

$$Correl ( X , Y ) = \frac{\sum ( x - \overline{x} ) ( y - \overline{y} )}{\sqrt{\sum {( x - \overline{x} )}^{2} \sum {( y - \overline{y} )}^{2}}} \qquad Equation 2$$

As described above, in the antenna having multiple radiating elements, since the direction (target angle) of the beam is set by changing the excitation phase of feeding to the feed point, the excitation phase cannot be set and the direction of the beam is only one direction (0°) in a case where the number of radiating elements is one.

As illustrated in the table in FIG. 15, for both TE incidence and TM incidence, as the number of radiating elements increases, the correlation coefficient between the value in the ideal model and the value in the real model increases.

A correlation coefficient of greater than or equal to 0.9 is regarded as good, and in the table of FIG. 15, cells of the correlation coefficient of less than 0.9 are filled with gray.

In FIG. 15, in the case of TE incidence, the correlation is poor when the number of radiating elements is one, good when the number of radiating elements is two at the target angles of 0° and 20°, and good when the number of radiating elements is four at the target angles of 0°, 20°, and 40°. In the case of TM incidence, the correlation is poor when the number of radiating elements is one, good when the number of radiating elements is two at only the target angle of 0°, and good when the number of radiating elements is four at the target angles of 0°, 20°, or 40°.

Therefore, it is preferable to provide at least 4 radiating elements arranged in the scanning direction in the antenna considering both TE incidence and TM incidence. If the correlation coefficient being greater than or equal to 0.95 is assumed to be further favorable, it is more preferable to provide at least 16 radiating elements in the antenna.

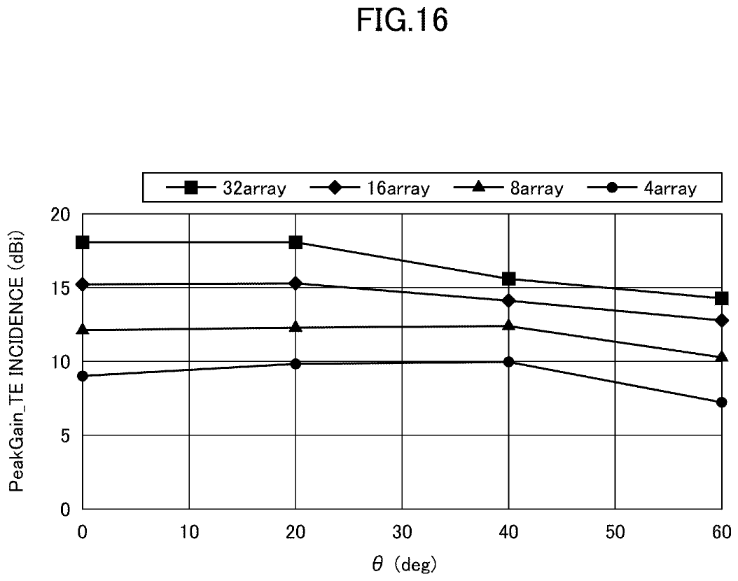

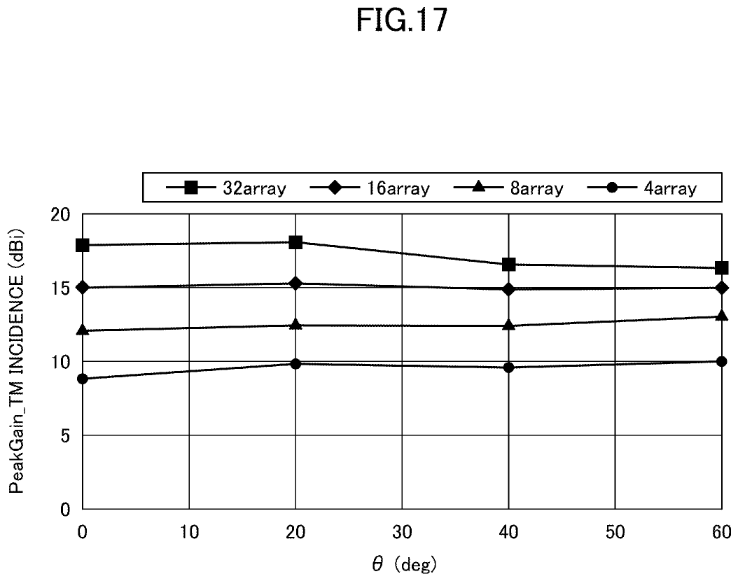

Next, FIG. 16 and FIG. 17 illustrate peak gains extracted from gains obtained by setting beam directions (target angles) to 0°, 20°, 40°, and 60° and simulating the gains in the antenna having different numbers of radiating elements.

For example, a line for 32array in FIG. 16 is created by plotting and connecting the peak gains around the respective target angles in the four gain waveforms for each target angle of a real model C32e (d20) illustrated by the solid line in FIG. 11.

Here, in the real model C32e having thirty two radiating elements in FIG. 9A to FIG. 9C, the simulations were performed, as respective analysis models, by feeding and exciting four, eight, sixteen, and thirty two feed points P1 at the center. FIG. 16 illustrates peak gains of TE incidence around the target angles of 0°, 20°, 40°, and 60° in the case where the numbers of antenna elements arranged at 20 mm apart from the insulated glass are four, eight, sixteen, and thirty two.

In the real model C32m having thirty two radiating elements in FIG. 10A to FIG. 10C, the simulations were performed, as real models for each number of elements, by feeding and exciting four, eight, sixteen, and thirty two feed points P2 at the center. FIG. 17 illustrates peak gains of TM incidence around the target angles of 0°, 20°, 40°, and 60° in the case where the numbers of antenna elements arranged at 20 mm apart from the insulated glass are four, eight, sixteen, and thirty two.

As illustrated in FIG. 16 and FIG. 17, the peak gains around the target angles of 0°, 20°, 40°, and 60° in the real models of TM incidence and TE incidence in which the number of elements to be excited is changed increase as the number of antenna elements (radiating elements) increases.

In the table of FIG. 15, the correlation coefficients at the target angle 60° were poor in most cases, however, for example, as illustrated in FIG. 11 and FIG. 12, in a case where the number of excited elements is thirty two and the target angle is 60°, the peak value (maximum value) of the gain of the real model is larger than that of the ideal model, and is 14 dBi for TE incidence and 16 dBi for TM incidence as illustrated in FIG. 16 and FIG. 17.

As illustrated in FIG. 16 and FIG. 17, in a case where the number of elements to be excited is sixteen and the target angle is 60°, the peak gain around the target angle is 13 dBi for TE incidence and 15 dBi for TM incidence. In a case where the number of elements to be excited is eight and the target angle is 60°, the peak gain around the target angle is 10 dBi for TE incidence and 13 dBi for TM incidence. In a case where the number of elements to be excited is four and the target angle is 60°, the peak gain around the target angle is 7 dBi for TE incidence and 10 dBi for TM incidence.

As described above, in the cases that the numbers of elements to be excited in the antenna are four, eight, sixteen, and thirty two, the peak gains of the TM incidence around the target angles of 0°, 20°, 40°, and 60° can be ensured to be greater than or equal to 5 dBi, and thus any configurations above can operate favorably as an antenna.

Therefore, as long as at least four radiating elements are arranged in the scanning direction to which radiation is performed obliquely from the antenna, the effects of the oblique incidence characteristic and the unwanted mode due to the arrangement of the glass around the antenna illustrated in FIG. 3A to FIG. 3C are mitigated, and the array antenna can radiate a beam in an intended direction.

Furthermore, since the effects of the oblique incidence characteristic and the unwanted mode are changed in accordance with the distance between the glass and the antenna (the distance between the glass and the antenna substrate, hereinafter referred to as an antenna-glass distance d), the characteristics of the antenna were simulated by changing the distance d.

### Example 3: Simulation of Insulated Glass with Different Antenna-Glass Distances

In the real models C32e and C32m in which thirty two antenna elements are arranged in the scanning direction illustrated in FIG. 9A to FIG. 10C, the inventors of the present disclosure studied the antenna characteristics by changing the antenna-glass distance d illustrated in FIG. 6.

### Case where Distance d is 5 mm

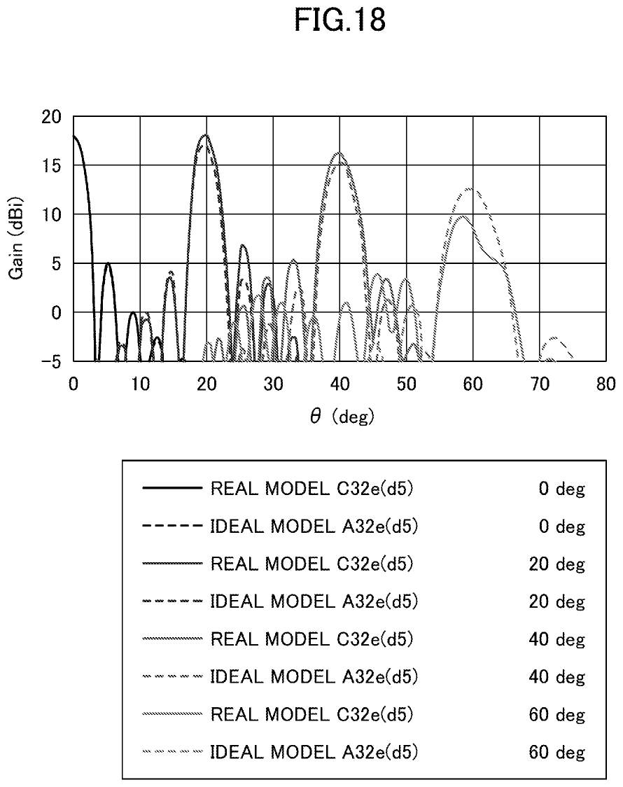

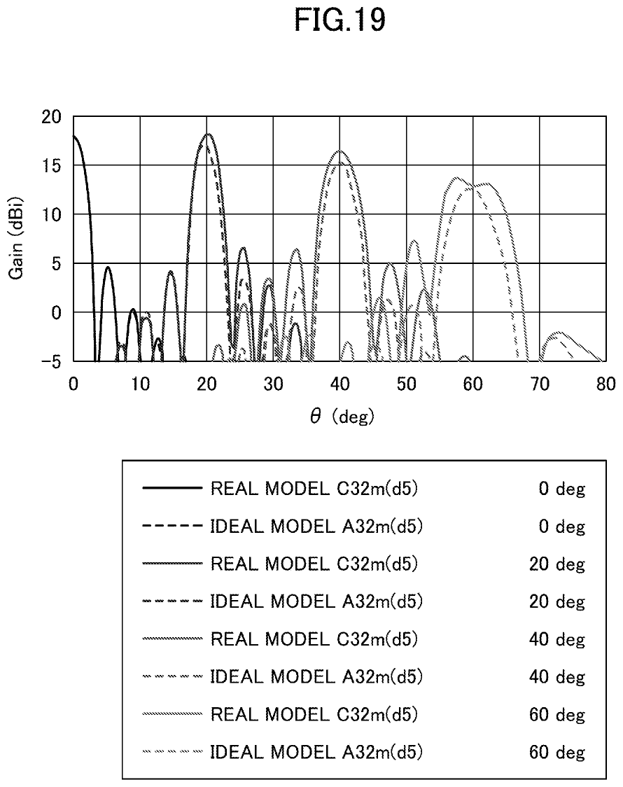

FIG. 18 and FIG. 19 illustrate the antenna characteristics in a case where the antenna-glass distance d is 5 mm in the insulated glass. First, the distance d of the ideal model A, which is the single-element infinite periodic analysis model illustrated in FIG. 4, was adjusted to 5 mm, TE incidence and TM incidence with one element were analyzed, and based on the analysis results, the antenna characteristics of the ideal models A32e (d5) and A32m (d5) in the case where thirty two elements are arranged were simulated using the theoretical formula.

In the real model C32e (d5) having thirty two radiating elements and having the antenna-glass distance d of 5 mm, radiation gains at a frequency of 28 GHz when TE incidence was performed by feeding and exciting thirty two feed points P1 were simulated. FIG. 18 is a graph illustrating the gains of TE incidence at the target angles of 0°, 20°, 40°, and 60° in the case of the ideal model A32e (d5) and in a case where thirty two antenna elements are arranged in the scanning direction and at 5 mm apart from the insulated glass.

Furthermore, in the real model C32m (d5) having thirty two radiating elements and having the antenna-glass distance d of 5 mm, radiation gains at a frequency of 28 GHz when TM incidence was performed by feeding and exciting thirty two feed points P2 were simulated. FIG. 19 is a graph illustrating the gains of TM incidence at the target angles of 0°, 20°, 40°, and 60° in the case of the ideal model A32m (d5) and in the case where thirty two antenna elements are arranged in the scanning direction and at 5 mm apart from the insulated glass.

As illustrated in FIG. 18 and FIG. 19, when the gain waveforms of the infinite periodic ideal models A32e (d5) and A32m (d5) indicated by the broken line and the gain waveforms of the real models C32e (d5) and C32m (d5) indicated by the solid line are compared to each other, there are mountain-shaped maximum values (peaks) at positions close to the target angles of 0°, 20°, 40°, and 60°. Therefore, it is shown that the radiation gain for each angle tends to be similar between the ideal model A32e (d5) and the real model C32e (d5) and between the ideal model A32m (d5) and the real model C32m (d5).

However, for both TE incidence and TM incidence, in the gains of the real models C32e (d5) and C32m (d5) indicated by the solid line with respect to the beam having the target angle of 60°, each peak is split into peaks unlike the respective ideal model indicated by the broken line. Here, the peak gain of the largest peak among the split peaks at the target angle of 60° in the radiation gain of the real model C32e (d5) is 10 dBi for TE incidence, and the peak gain in the radiation gain of the real model C32m (d5) is 14 dBi for TM incidence.

### Case where Distance d is 10 mm

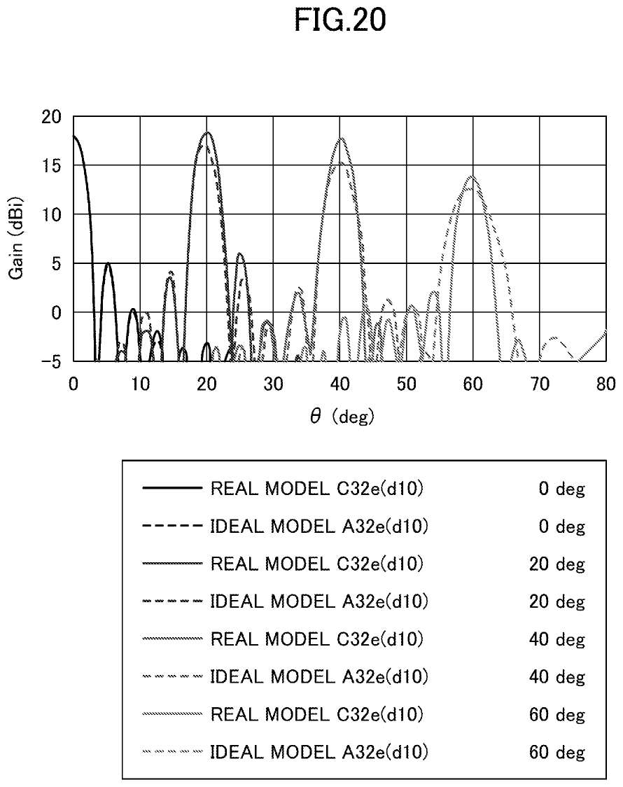

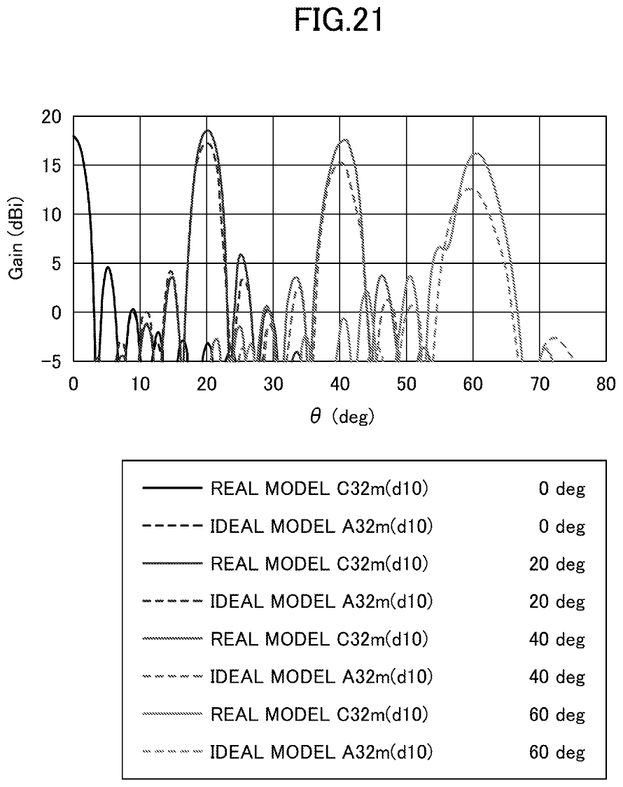

FIG. 20 and FIG. 21 illustrate the antenna characteristics in a case where the antenna-glass distance d is 10 mm in the insulated glass. First, the distance d of the ideal model A, which is the single-element infinite periodic analysis model illustrated in FIG. 4, was adjusted to 10 mm, TE incidence and TM incidence with one element were analyzed, and based on the analysis results, the antenna characteristics of the ideal models A32e (d10) and A32m (d10) in the case where thirty two elements are arranged were simulated using the theoretical formula.

In the real model C32e (d10) having thirty two radiating elements and having the antenna-glass distance d of 10 mm, radiation gains at a frequency of 28 GHz when TE incidence was performed by feeding and exciting thirty two feed points P1 were simulated. FIG. 20 is a graph illustrating the gains of TE incidence at the target angles of 0°, 20°, 40°, and 60° in the case of the ideal model A32e (d10) and in the case where thirty two antenna elements are arranged in the scanning direction and at 10 mm apart from the insulated glass.

In the real model C32m (d10) having thirty two radiating elements and having the antenna-glass distance d of 10 mm, radiation gains at a frequency of 28 GHz when TM incidence was performed by feeding and exciting thirty two feed points P2 were simulated. FIG. 21 is a graph illustrating the gains of TM incidence at the target angles of 0°, 20°, 40°, and 60° in the case of the ideal model A32m (d10) and in the case where thirty two antenna elements are arranged in the scanning direction and at 10 mm apart from the insulated glass.

As illustrated in FIG. 20 and FIG. 21, when the gain waveforms of the ideal models A32e (d10) and A32m (d10) indicated by the broken line and the gain waveforms of the real models C32e (d10) and C32m (d10) indicated by the solid line are compared to each other, there are mountain-shaped maximum values (peaks) at positions close to the target angles of 0°, 20°, 40°, and 60°. Therefore, it is shown that, the radiation gain for each angle tends to be generally similar between the ideal model A32e (d10) and the real model C32e (d10) and between the ideal model A32m (d10) and the real model C32m (d10).

However, for TM incidence, in the gains of the real model C32m (d10) indicated by the solid line with respect to the beam having the target angle of 60°, a distorted mountain shape is formed unlike the ideal model indicated by the broken line, yet the peak gain at the target angle of 60° in the real model C32m (d10) is 16 dBi.

### Case where Distance d is 50 mm

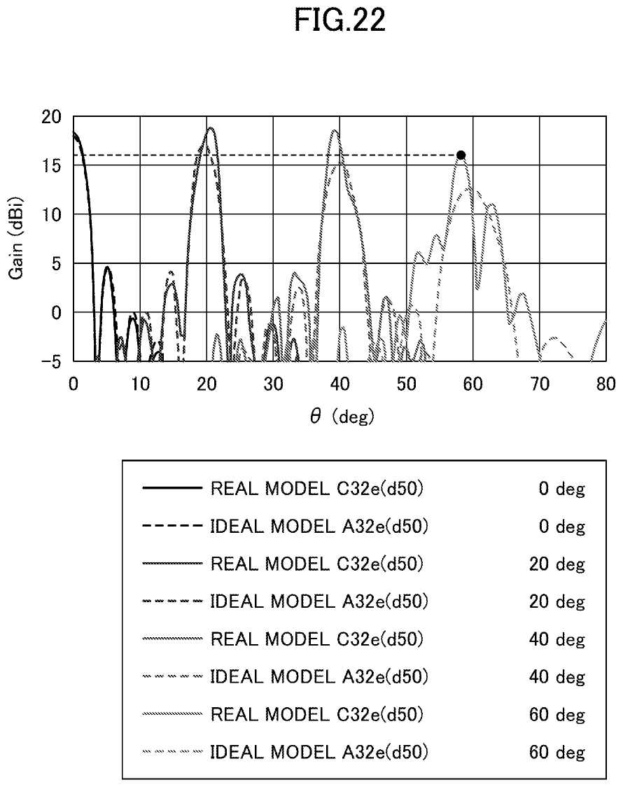

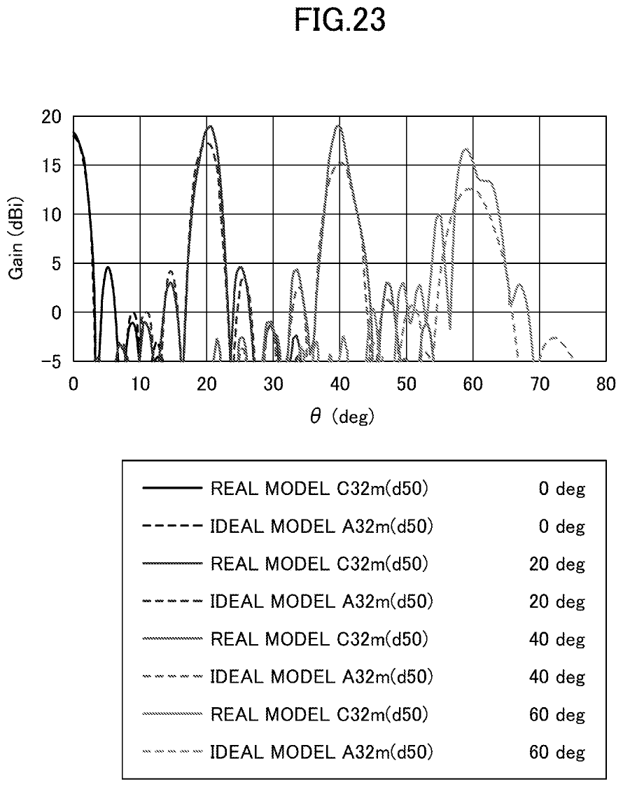

FIG. 22 and FIG. 23 illustrate the antenna characteristics in a case where the antenna-glass distance d is 50 mm in the insulated glass. First, the distance d of the ideal model A, which is the single-element infinite periodic analysis model illustrated in FIG. 4, was adjusted to 50 mm, TE incidence and TM incidence with one element were analyzed, and based on the analysis results, the antenna characteristics of the ideal models A32e (d50) and A32m (d50) in the case where thirty two elements are arranged were simulated using the theoretical formula.

In the real model C32e (d50) having thirty two radiating elements and having the antenna-glass distance d of 50 mm, radiation gains at a frequency of 28 GHz when TE incidence was performed by feeding and exciting thirty two feed points P1 were simulated. FIG. 22 is a graph illustrating the gains of TE incidence at the target angles of 0°, 20°, 40°, and 60° in the case of the ideal model A32e (d50) and in the case where thirty two antenna elements are arranged in the scanning direction and at 50 mm apart from the insulated glass.

In the real model C32m (d50) having thirty two radiating elements and having the antenna-glass distance d of 50 mm, radiation gains at a frequency of 28 GHz when TM incidence was performed by feeding and exciting thirty two feed points P2 were simulated. FIG. 23 is a graph illustrating the gains of TM incidence at the target angles of 0°, 20°, 40°, and 60° in the case of the ideal model A32m (d50) and in the case where thirty two antenna elements are arranged in the scanning direction and at 50 mm apart from the insulated glass.

As illustrated in FIG. 22 and FIG. 23, when the gain waveforms of the infinite periodic ideal models A32e (d50) and A32m (d50) indicated by the broken line and the gain waveforms of the real models C32e (d50) and C32m (d50) indicated by the solid line are compared to each other, there are mountain-shaped maximum values (peaks) at positions close to the target angles of 0°, 20°, 40°, and 60°. Therefore, it is shown that, the radiation gain for each angle tends to be generally similar between the ideal model A32e (d50) and the real model C32e (d50) and between the ideal model A32m (d50) and the real model C32m (d50).

However, for TE incidence of FIG. 22, in the gain waveform of the real model C32e (d50) indicated by the solid line with respect to the beam having the target angle of 60°, the peak is split into peaks unlike the ideal model indicated by the broken line, yet the peak gain at the target angle of 60° in the real model C32e (d50) is 16 dBi.

Furthermore, for TM incidence of FIG. 23, in the gain waveform of the real model C32m (d50) indicated by the solid line with respect to the beam having the target angle of 60°, the peak is split into peaks unlike the ideal model indicated by the broken line and a distorted mountain shape is formed. Here, the peak gain at the target angle of 60° in the real model C32m (d50) is 17 dBi.

Although not illustrated in the graph, the inventors of the present disclosure simulated the radiation gains at a frequency of 28 GHz for TM incidence and TE incidence at the target angles of 0°, 20°, 40°, and 60° for cases that the antenna-glass distances d are 30, and 40 mm, in addition to the above described cases that the distances d are 5, 10, 20, and 50 mm.

### Correlation for Each Distance d

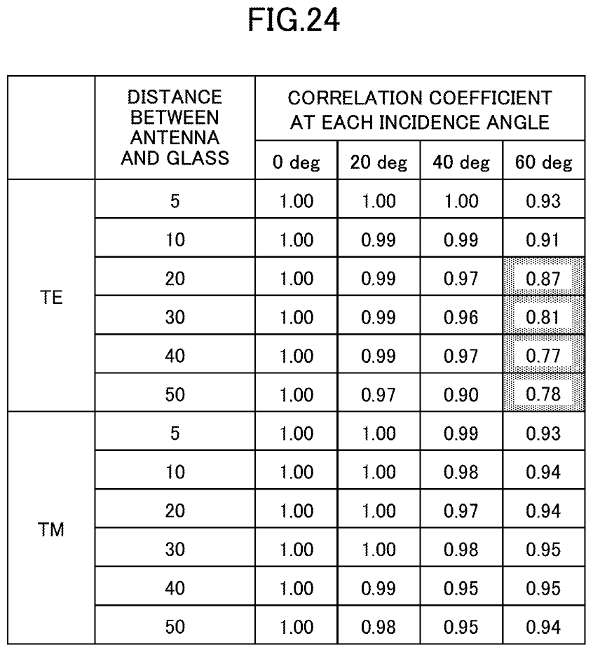

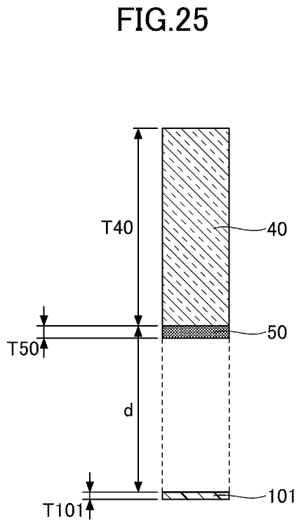

FIG. 24 is a table illustrating correlation coefficients between the gain value in the real model and the gain value in the ideal model at each angle in a case where thirty two antenna elements are arranged at a distance apart from the insulated glass, the distance being 5, 10, 20, 30, 40, and 50 mm. Equation (2), which is the same as that used in FIG. 15, was used to calculate the correlation coefficient.

As illustrated in the table of FIG. 24, in both cases of TE incidence and TM incidence, the correlation coefficient tends to be higher as the antenna-glass distance d is shorter.

A correlation coefficient of greater than or equal to 0.9 is regarded as good, and in the table of FIG. 24, cells of the correlation coefficients of less than 0.9 are filled with gray.

Here, in FIG. 24, for TE incidence, the correlation coefficients are less than 0.9 for the distances of 20, 30, 40, and 50 mm at the target angle of 60°. For TM incidence, the correlation coefficients are greater than or equal to 0.9 for all distances of 5, 10, 20, 30, 40, and 50 mm at all target angles of 0°, 20°, 40°, and 60°.

Here, when the distance d is 20 mm, the configuration is the same as that of the real models C32e and C32m illustrated in the above-described FIG. 9A to FIG. 10C, and the radiation gains of the real models C32e and C32m are as illustrated in the above-described FIG. 11 and FIG. 12. In FIG. 24, the correlation coefficient at the target angle of 60° for TE incidence of the analysis model in which the distance d is 20 mm is less than 0.9; however, as illustrated in FIG. 11, the peak gain at the target angle of 60° for TE incidence of the real model C32e (d20) is 14 dBi.

Furthermore, as illustrated in FIG. 11, FIG. 12, and FIG. 18 to FIG. 23, it is considered that the decrease in the correlation coefficient at the target angle of 60° occurs because, in the gains of the real model, a large peak is split or has a distorted mountain shape. However, even if the peak shape of the gain waveform is split, the peak gain at the target angle of 60° for TE incidence in the case where the distance d is 50 mm is 16 dBi as illustrated in FIG. 22.

Although it is not illustrated in the graph, for the real models C32e and C32m in which the number of radiating elements is thirty two and the correlation coefficient is less than 0.9, the peak gain at the target angle of 60° for TE incidence in the case where the distance d is 30 mm is 15 dBi, and the peak gain at the target angle of 60° for TE incidence in the case where the distance d is 40 mm is 16 dBi.

Therefore, even when the correlation coefficient is less than 0.9 in the real models C32e and C32m in which the distances d are 30 mm, 40 mm, and 50 mm, the peak gains can be ensured to be greater than or equal to 10 dBi, and the scan losses (the amount of decrease in gain when the target angle is changed) when the target angle is changed to 0 through to 60° are less than or equal to 3 to 5 dBi. Since the decrease in the directional gain at 60° of a general microstrip antenna is about 3 dBi, it can be said that the decrease in the scan loss in the present disclosure is sufficiently small.

Accordingly, in the present disclosure, it is preferable that the antenna-glass distance d is less than or equal to 50 mm, for example, 5 to 50 mm, in the case where the array antenna is disposed close to the insulated glass. In other words, it is preferable that the antenna-glass distance d is less than or equal to 5.0 λ₀.

In this example, although the simulation is performed with the antenna-glass distance of 5 mm as the smallest value, the antenna-glass distance may be further reduced. However, since the resonance frequency is shifted if the antenna and the glass are in contact with each other, the antenna and the glass are arranged in a non-contact manner.

### Example 4: Simulation of Single Glass with Different Antenna-Glass Distances

In this example, a single glass constituted by one glass plate was used as window glass to form a real model D.

FIG. 25 is a cross-sectional view of analysis models (the real model D and an ideal model S) in which an antenna element is disposed apart from a single glass with a matching layer. In the real model D and the ideal model S, the single glass 40 constituted by one glass plate was used as window glass.

In FIG. 25, assuming that the thickness of the glass is T40, and set as follows:
T40: 19 mm;
T50: 1 mm; and
T101: 1 mm.

The arrangement of the antenna elements 102 of the array antenna 10 and the positions of the feed points P1 and P2 in the real model D are the same as those in FIG. 9C in the case of TE incidence, and are the same as those in FIG. 10C in the case of TM incidence.

In the real model D in which thirty two antenna elements are arranged in the scanning direction and the single glass is disposed facing the antenna elements as illustrated in FIG. 25, the inventors of the present disclosure studied antenna characteristics by changing the antenna-glass distance d. In such a case, the insulated glass of the ideal model A, which is the single-element infinite periodic analysis model illustrated in FIG. 4, was replaced with a single glass having a glass thickness of 40 mm, and the antenna characteristics were simulated with different antenna-glass distances d for the ideal model S, which is the single-element infinite periodic analysis model for a single glass plate. The ideal model S has the same cross-sectional view as illustrated in FIG. 25.

### Case where Distance d is 5 mm

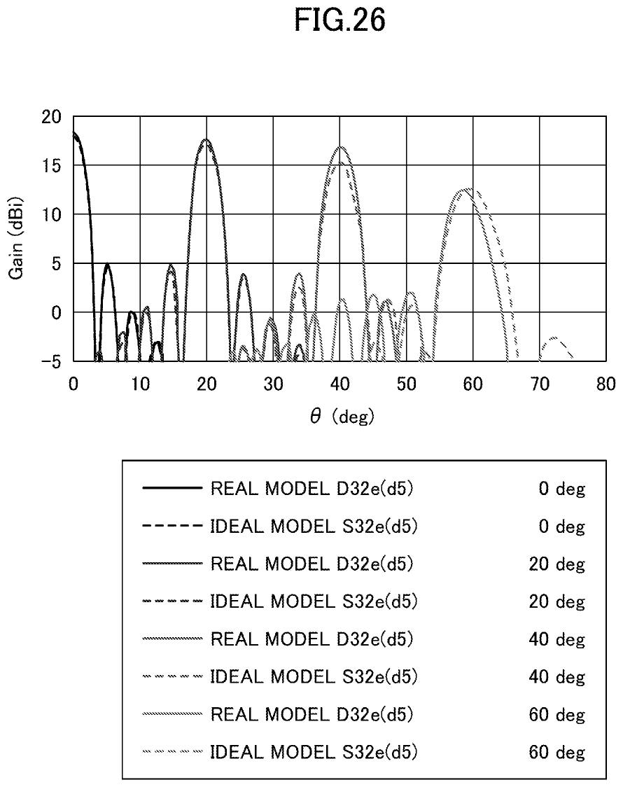

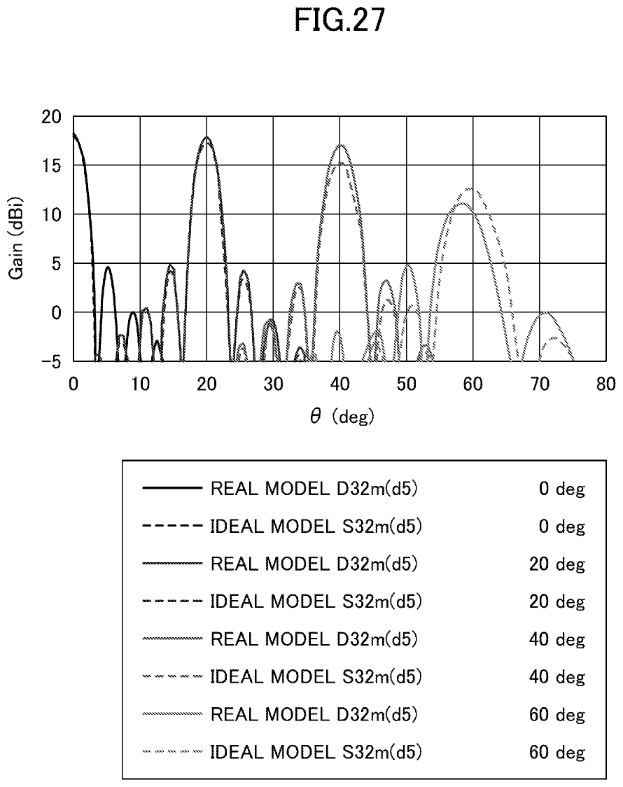

FIG. 26 and FIG. 27 illustrate the characteristics in a case where the glass is single glass and the antenna-glass distance d is 5 mm. First, the distance d of the ideal model S, which is the single-element infinite periodic analysis model for single glass, was adjusted to 5 mm, TE incidence and TM incidence with one element were analyzed, and based on the analysis results, the antenna characteristics of ideal models S32e (d5) and S32m (d5) in the case where thirty two elements are arranged were simulated using the theoretical formula.

In a real model D32e (d5) having thirty two radiating elements and having an antenna-glass distance d of 5 mm, radiation gains at a frequency of 28 GHz when TE incidence was performed by feeding and exciting thirty two feed points P1 were simulated. FIG. 26 is a graph illustrating the gains of TE incidence at the target angles of 0°, 20°, 40°, and 60° in the case of the ideal model S32e (d5) and in a case where thirty two antenna elements are arranged in the scanning direction and at 5 mm apart from the single glass.

Furthermore, in a real model D32m (d5) having thirty two radiating elements and having an antenna-glass distance d of 5 mm, radiation gains at a frequency of 28 GHz when TM incidence was performed by feeding and exciting thirty two feed points P2 were simulated. FIG. 27 is a graph illustrating the gains of TM incidence at the target angles of 0°, 20°, 40°, and 60° in the case of the ideal model S32m (d5) and in the case where thirty two antenna elements are arranged in the scanning direction and at 5 mm apart from the single glass.

As illustrated in FIG. 26 and FIG. 27, when the gain waveforms of the ideal models S32e (d5) and S32m (d5) indicated by the broken line and the gain waveforms of the real models D32e (d5) and D32m (d5) indicated by the solid line are compared to each other, there are mountain-shaped maximum values (peaks) at positions close to the target angles of 0°, 20°, 40°, and 60°. Therefore, it is shown that, the radiation gain for each angle tends to be generally considerably similar between the ideal model S32e (d5) and the real model D32e (d5) and between the ideal model S32m (d5) and the real model D32m (d5). Even in the radiation gain at 60° in the real models D32e (d5) and D32m (d5) indicated by the solid line, no mountain-shaped split has occurred.

### Case where Distance d is 10 mm

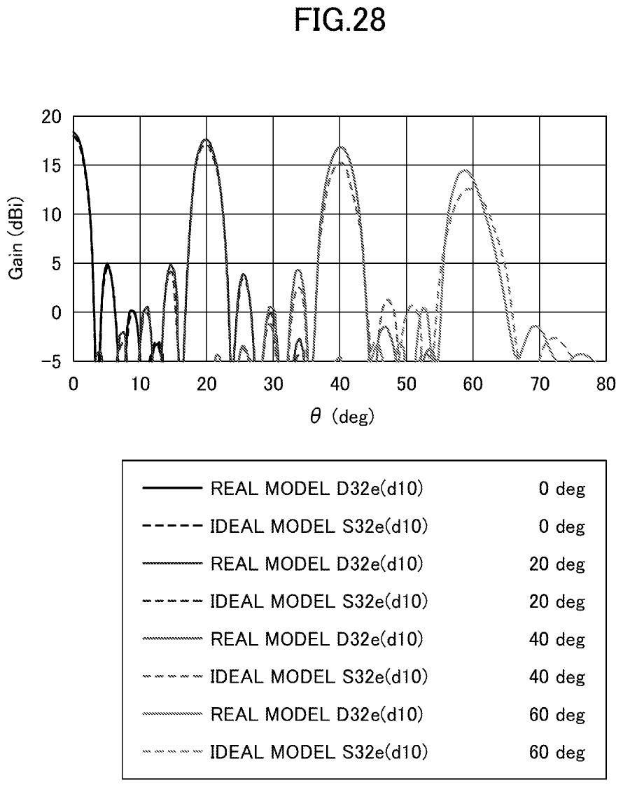

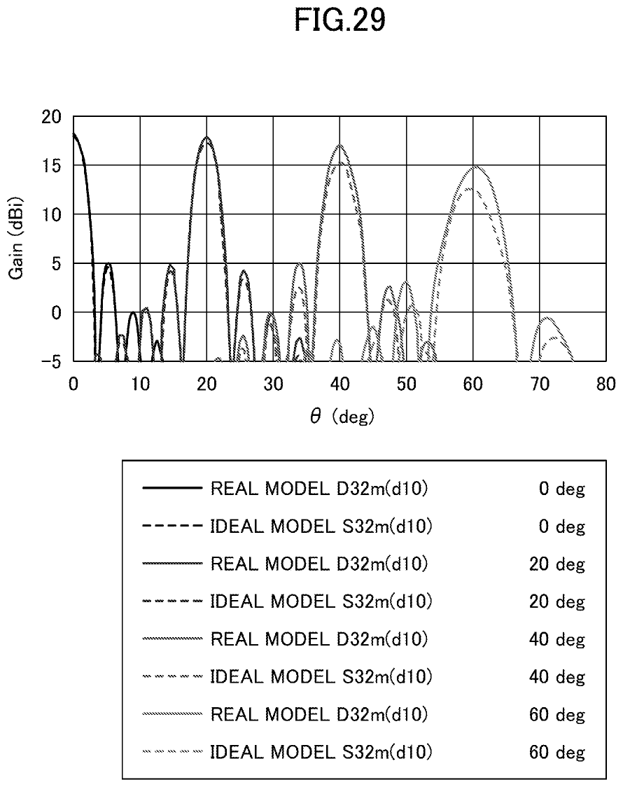

FIG. 28 and FIG. 29 illustrate the characteristics in a case where the glass is single glass and the antenna-glass distance d is 10 mm. First, the distance d of the ideal model S, which is the single-element infinite periodic analysis model for single glass, was adjusted to 10 mm, TE incidence and TM incidence with one element were analyzed, and based on the analysis results, the antenna characteristics of ideal models S32e (d10) and S32m (d10) in the case where thirty two elements are arranged were simulated using the theoretical formula.

In a real model D32e (d10) having thirty two radiating elements and having an antenna-glass distance d of 10 mm, radiation gains at a frequency of 28 GHz when TE incidence was performed by feeding and exciting thirty two feed points P1 were simulated. FIG. 28 is a graph illustrating the gains of TE incidence at the target angles of 0°, 20°, 40°, and 60° in the case of the ideal model S32e (d10) and in a case where thirty two antenna elements are arranged in the scanning direction and at 10 mm apart from the single glass.

In a real model D32m (d10) having thirty two radiating elements and having an antenna-glass distance d of 10 mm, radiation gains at a frequency of 28 GHz when TM incidence was performed by feeding and exciting thirty two feed points P2 were simulated. FIG. 29 is a graph illustrating the gains of TM incidence at the target angles of 0°, 20°, 40°, and 60° in the case of the ideal model S32m (d10) and in the case where thirty two antenna elements are arranged in the scanning direction and at 10 mm apart from the single glass.

As illustrated in FIG. 28 and FIG. 29, when the gain waveforms of the ideal models S32e (d10) and S32m (d10) indicated by the broken line and the gain waveforms of the real models D32e (d10) and D32m (d10) indicated by the solid line are compared to each other, there are mountain-shaped maximum values (peaks) at positions close to the target angles of 0°, 20°, 40°, and 60°. Therefore, it is shown that, the radiation gain for each angle tends to be generally considerably similar between the ideal model S32e (d10) and the real model D32e (d10) and between the ideal model S32m (d10) and the real model D32m (d10). Furthermore, even in the radiation gain at 60° in the real models D32e (d10) and D32m (d10) indicated by the solid line, no mountain-shaped split has occurred.

### Case where Distance d is 20 mm

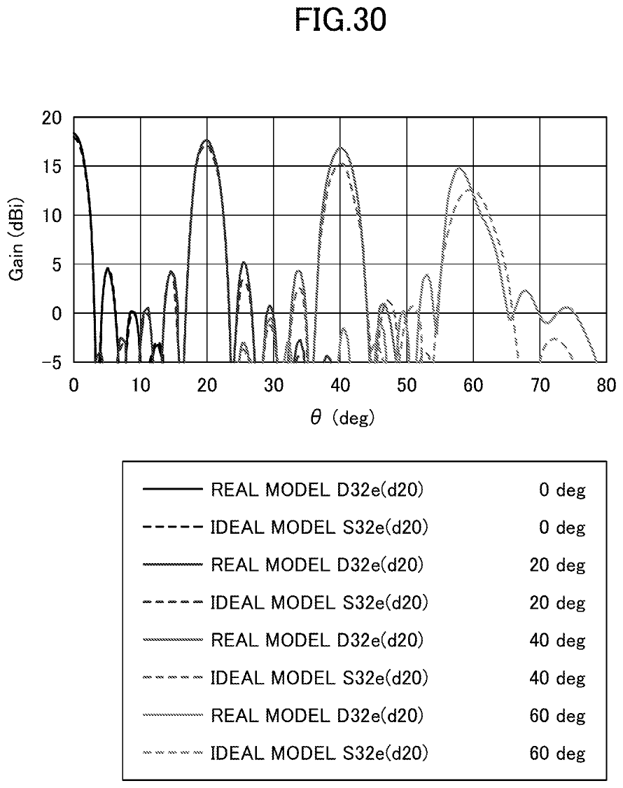

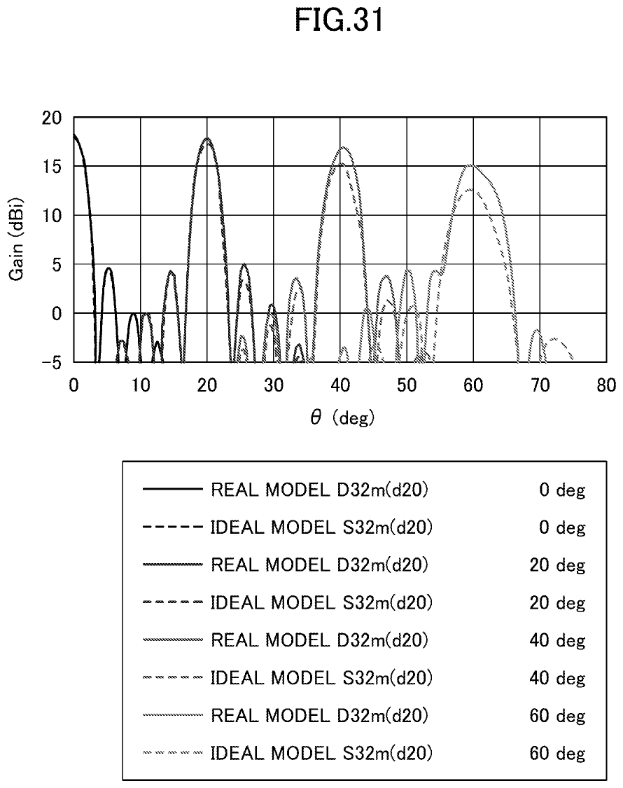

FIG. 30 and FIG. 31 illustrate the characteristics in a case where the glass is single glass and the antenna-glass distance d is 20 mm. First, the distance d of the ideal model S, which is the single-element infinite periodic analysis model for single glass, was adjusted to 20 mm, TE incidence and TM incidence with one element were analyzed, and based on the analysis results, the antenna characteristics of ideal models S32e (d20) and S32m (d20) in the case where thirty two elements are arranged were simulated using the theoretical formula.

In a real model D32e (d20) having thirty two radiating elements and having an antenna-glass distance d of 20 mm, radiation gains at a frequency of 28 GHz when TE incidence was performed by feeding and exciting thirty two feed points P1 were simulated. FIG. 30 is a graph illustrating the gains of TE incidence at the target angles of 0°, 20°, 40°, and 60° in the case of the ideal model S32e (d20) and in the case where thirty two antenna elements are arranged in the scanning direction and at 20 mm apart from the single glass.

In a real model D32m (d20) having thirty two radiating elements and having an antenna-glass distance d of 20 mm, radiation gains at a frequency of 28 GHz when TM incidence was performed by feeding and exciting thirty two feed points P2 were simulated. FIG. 31 is a graph illustrating the gains of TM incidence at the target angles of 0°, 20°, 40°, and 60° in the case of the ideal model S32m (d20) and in the case where thirty two antenna elements are arranged in the scanning direction and at 20 mm apart from the single glass.

As illustrated in FIG. 30 and FIG. 31, when the gain waveforms of the ideal models S32e (d20) and S32m (d20) indicated by the broken line and the gain waveforms of the real models D32e (d20) and D32m (d20) indicated by the solid line are compared to each other, there are mountain-shaped maximum values (peaks) at positions close to the target angles of 0°, 20°, 40°, and 60°. Therefore, it is shown that, the radiation gain for each angle tends to be generally considerably similar between the ideal model S32e (d20) and the real model D32e (d20) and between the ideal model S32m (d20) and the real model D32m (d20). Furthermore, even in the radiation gain at 60° in the real models D32e (d20) and D32m (d20) indicated by the solid line, no mountain-shaped split has occurred.

### Case where Distance d is 50 mm

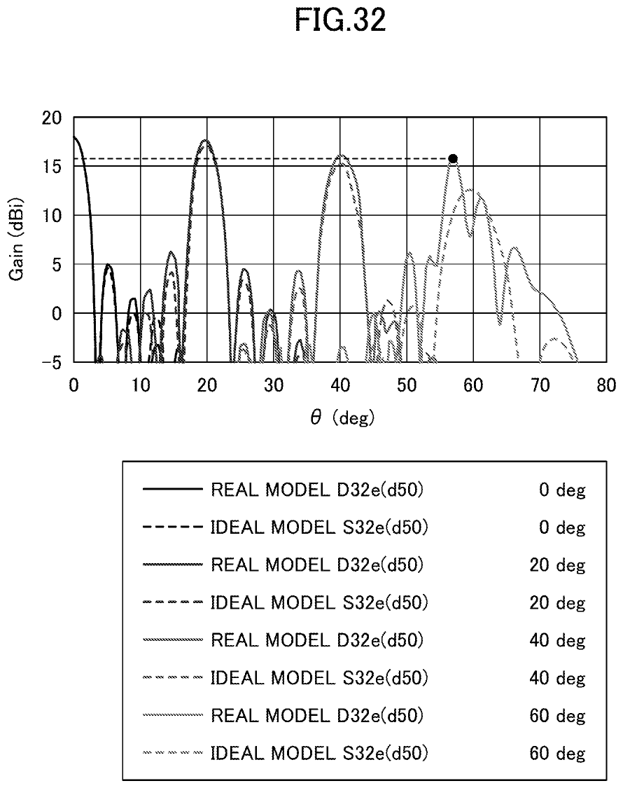

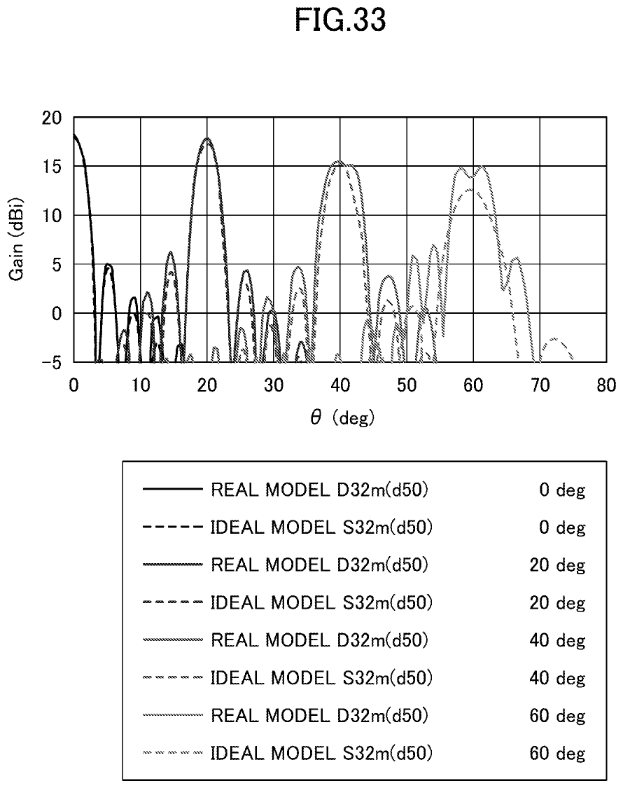

FIG. 32 and FIG. 33 illustrate the characteristics in a case where the glass is single glass and the antenna-glass distance d is 50 mm. First, the distance d of the ideal model S, which is the single-element infinite periodic analysis model for single glass, was adjusted to 50 mm, TE incidence and TM incidence with one element were analyzed, and based on the analysis results, the antenna characteristics of ideal models S32e (d50) and S32m (d50) in the case where thirty two elements are arranged were simulated using the theoretical formula.

In a real model D32e (d50) having thirty two radiating elements and having an antenna-glass distance d of 50 mm, radiation gains at a frequency of 28 GHz when TE incidence were performed by feeding and exciting thirty two feed points P1 were simulated. FIG. 32 is a graph illustrating the gains of TE incidence at the target angles of 0°, 20°, 40°, and 60° in the case of the ideal model S32e (d50) and in the case where thirty two antenna elements are arranged in the scanning direction and at 50 mm apart from the single glass.

In a real model D32m (d50) having thirty two radiating elements and having an antenna-glass distance d of 50 mm, radiation gains at a frequency of 28 GHz when TM incidence was performed by feeding and exciting thirty two feed points P2 were simulated. FIG. 33 is a graph illustrating the gains of TM incidence at the target angles of 0°, 20°, 40°, and 60° in the case of the ideal model S32m (d50) and in the case where thirty two antenna elements are arranged in the scanning direction and at 50 mm apart from the single glass.

As illustrated in FIG. 32 and FIG. 33, when the gain waveforms of the ideal models S32e (d50) and S32m (d50) indicated by the broken line and the gain waveforms of the real models D32e (d50) and D32m (d50) indicated by the solid line are compared to each other, there are mountain-shaped maximum values (peaks) at positions close to the target angles of 0°, 20°, 40°, and 60° . Therefore, it is shown that, the radiation gain for each angle tends to be similar between the ideal model S32e (d50) and the real model D32e (d50) and between the ideal model S32m (d50) and the real model D32m (d50).

However, for both TE incidence and TM incidence, in the gains of the real models D32e (d50) and D32m (d50) indicated by the solid line with respect to the beam having the target angle of 60°, each peak is split into peaks unlike the respective ideal model indicated by the broken line. Here, the peak gain of the largest peak among the split peaks at the target angle of 60° in the radiation gain of the real model D32e (d50) is 16 dBi for TE incidence, and the peak gain in the radiation gain of the real model D32m (d50) is 15 dBi for TM incidence.

Although not illustrated in the graph, in the real model in which an array antenna is disposed close to a single glass, the inventors of the present disclosure simulated the radiation gains at a frequency of 28 GHz for TM incidence and TE incidence at the target angles of 0°, 20°, 40°, and 60° for cases that the antenna-glass distances d are 30, and 40 mm, in addition to the above described cases that the distances d are 5, 10, 20, and 50 mm.

### Correlation for Each Distance d

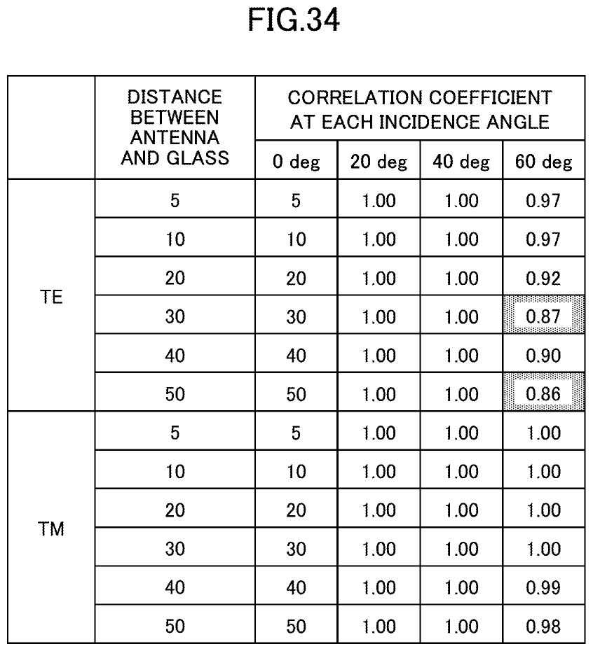

Here, FIG. 34 illustrates a table illustrating correlation coefficients between the gain value in the real model and the gain value in the ideal model at each angle in a case where thirty two antenna elements are arranged at a distance apart from the single glass, the distance being 5, 10, 20, 30, 40, and 50 mm. Equation (2), which is the same as that used in FIG. 15, was used to calculate the correlation coefficient.

As illustrated in the table of FIG. 34, in both cases of TE incidence and TM incidence, the correlation coefficient tends to be higher as the antenna-glass distance d is shorter. Furthermore, in the case of the single glass, since there is no interference of radio waves between the two glass plates illustrated in FIG. 3B, deterioration is small and a null does not readily appear, so that the correlation coefficient in the table is generally higher than that in the table of FIG. 24.

A correlation coefficient of greater than or equal to 0.9 is regarded as good, and in the table of FIG. 34, cells of the correlation coefficients of less than 0.9 are filled with gray.

Here, in FIG. 34, for TE incidence, the correlation coefficients are less than 0.9 for the distances of 30, and 50 mm at the target angle of 60°. For TM incidence, the correlation coefficients are greater than or equal to 0.9 for all distances of 5, 10, 20, 30, 40, and 50 mm at all target angles of 0°, 20°, 40°, and 60°.

Therefore, for both TE incidence and TM incidence, by selecting good coefficient values being greater than or equal to 0.9, the antenna-glass distance is preferable when it is 5 to 20 mm, even for a case of the single glass.

However, as illustrated in FIG. 32 described above, the decrease in the correlation coefficient at the target angle of 60° of TE incidence in the real model D32e (d50) occurs because a peak having a large radiation gain is split. However, even if the peak is split, the peak gain around at 60° when the radiation is performed obliquely from the antenna at the target angle of 60° is 16 dBi. Although it is not illustrated in the graph,

the peak gain around the target angle of 60° of TE incidence in the real model in which the correlation coefficient is less than 0.9 and the distance d is 30 mm is 15 dBi.

Therefore, even when the correlation coefficient is less than 0.9 in the real model D32e in which the distances d are 30 mm and 50 mm, the peak gains of TE incidence can be ensured to be greater than or equal to 10 dBi, and the scan losses when the target angle is changed to 0° through to 60° are less than or equal to 3 to 5 dBi. Since the decrease in the directional gain at 60° of a general microstrip antenna is about 3 dBi, it can be said that the decrease in the scan loss in the present disclosure is sufficiently small.

Accordingly, it is preferable that the antenna-glass distance d is less than or equal to 50 mm, for example, 5 to 50 mm, in a case where the array antenna is disposed close to the single glass. In other words, it is preferable that the antenna-glass distance d is less than or equal to 5.0 λ₀ even in the case of the single glass.

In this example, although the simulation is performed with the antenna-glass distance of 5 mm as the smallest value, the antenna-glass distance may be further reduced. However, since the resonant frequency is shifted if the antenna and the glass are in contact with each other, the antenna and the glass are arranged in a non-contact manner.

### Example 5: Comparison of Presence and Absence of Matching Layer

Although FIG. 2 illustrates the structure in which the matching layer is attached to the window glass and FIG. 6 and FIG. 25 illustrate the real model including the matching layer, the matching layer may not be provided to the window glass on which the antenna device of the present disclosure is disposed.

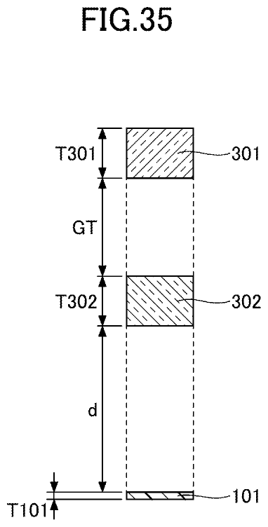

FIG. 35 is a cross-sectional view of a real model E in which an antenna element is disposed apart from the insulated glass without a matching layer. Here, the real model is different from the real models C32e and C32m in FIG. 9A to FIG. 10C in that there is no matching layer.

Note that the dimensions of each part, the antenna element arrangement, and the feed point position in the real model E are the same as those in FIG. 9C in the case of TE incidence, and are the same as those in FIG. 10C in the case of TM incidence.

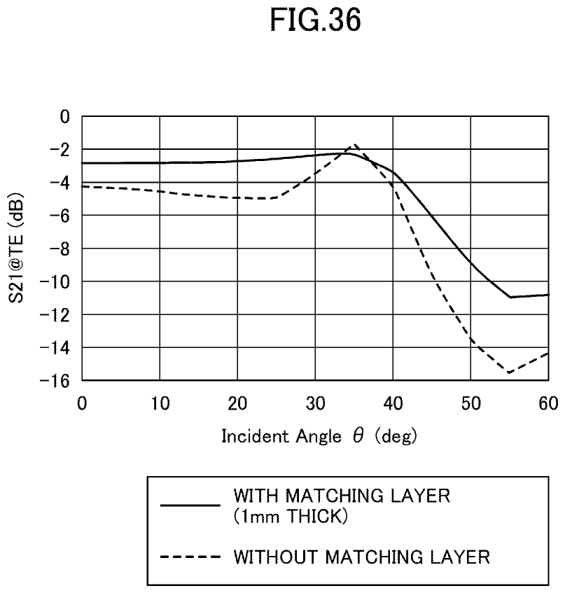

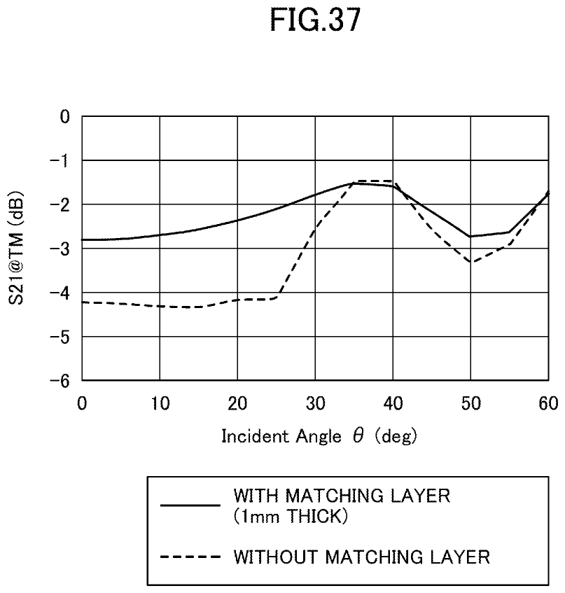

Here, the pass characteristics at the frequency of the 28 GHz when plane waves are incident from the far field were simulated. FIG. 36 illustrates a transmission coefficient S21 for TE incidence in a real model with a matching layer and in a real model without a matching layer. FIG. 37 illustrates the transmission coefficient S21 for TM incidence in the real model with a matching layer and the real model without a matching layer.

In FIG. 36 and FIG. 37, when the waveform without the matching layer indicated by the dotted line and the waveform with the matching layer indicated by the solid line are compared to each other, the transmission coefficient S21 of the waveform with the matching layer is generally higher at each angle except for a very small part of angles, and the pass characteristics are improved for both TE incidence and TM incidence. It is because that, by providing the matching layer 50, deterioration due to interference between the window glass and the radiating elements of the antenna can be suppressed (see FIG. 3A).

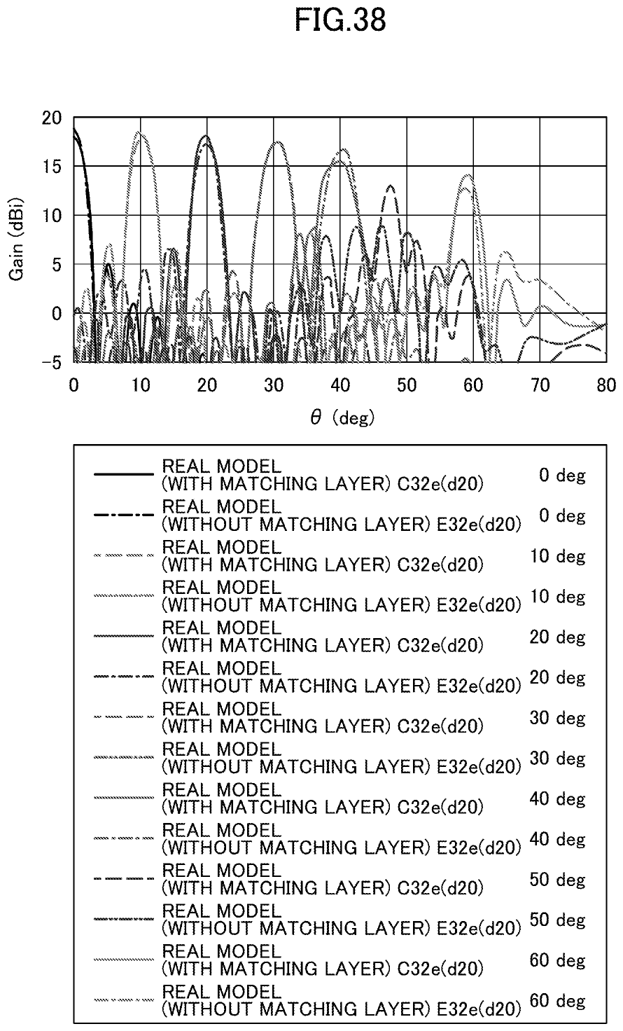

In the real model C32e (d20) and a real model E32e (d20) having thirty two radiating elements and having the antenna-glass distance d of 20 mm, radiation gains at a frequency of 28 GHz when TE incidence was performed by feeding and exciting thirty two feed points P1 were simulated. FIG. 38 is a graph illustrating the gains of TE incidence at the target angles of 0°, 10°, 20°, 30°, 40°, 50°, and 60° in the case where thirty two antenna elements are arranged in the scanning direction and at 20 mm apart from the insulated glass when there is a matching layer and when there is no matching layer.

In FIG. 38 for TE incidence, when the gain waveform of the real model C32e (d20) with the matching layer indicated by the solid line is compared with the gain waveform of the real model E32e (d20) without the matching layer indicated by the dotted line, the waveform of the configuration with the matching layer indicated by the solid line is better especially for the gains at the target angles of 20°, 50°, and 60°.

In particular, at the target angle of 50°, in the gain waveform without the matching layer, multi mountain-shaped peak gains having less than or equal to 10 dBi appear around at 50°, and the correlation coefficient between the gain of the real model without the matching layer and the gain of the ideal model is 0.40, which is extremely low. On the other hand, in the waveform with the matching layer especially around at 50°, a larger peak appears around at 50°, the correlation coefficient becomes higher than that without the matching layer, and the peak gain is improved to 13 dBi.

Accordingly, it can be said that the peak gain at the target angle is also improved at the angle at which the transmission coefficient S21 has been greatly improved by providing the matching layer in FIG. 36. Furthermore, as illustrated in FIG. 36, since the transmission coefficients generally increase at all angles, the influence of the ripple is less likely to occur at all angles, and noise in the gain waveform indicated by the solid line in FIG. 38 is reduced as compared with noise in the gain waveform indicated by the dotted line.

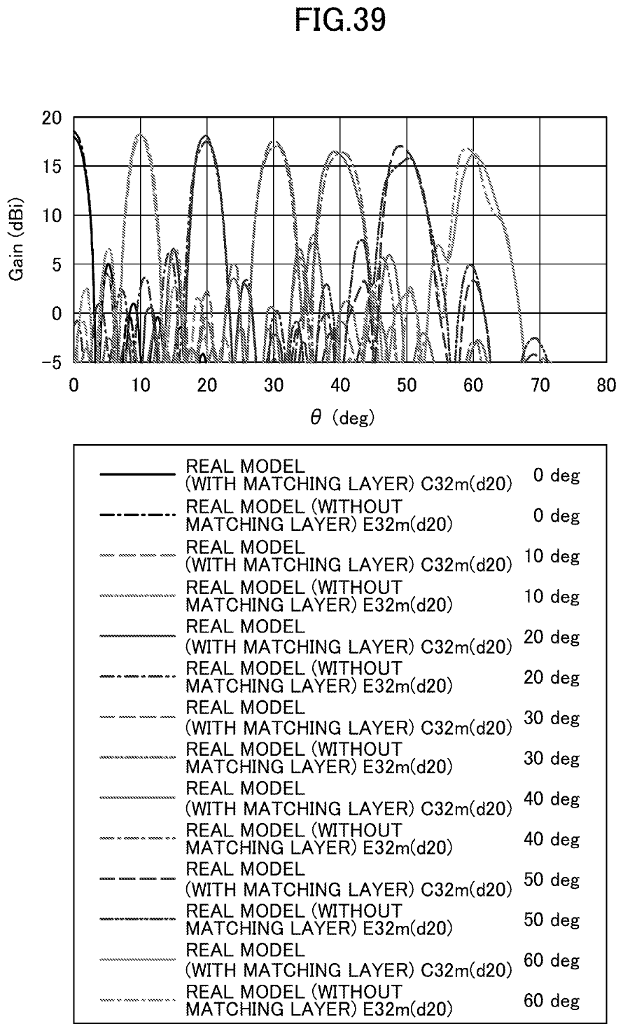

In a real model C32m (d20) and a real model E32m (d20) having thirty two radiating elements and having the antenna-glass distance d of 20 mm, radiation gains at a frequency of 28 GHz when TM incidence was performed by feeding and exciting thirty two feed points P2 were simulated. FIG. 39 is a graph illustrating the gains of TM incidence at the target angles of 0°, 10°, 20°, 30°, 40°, 50°, and 60° in the case where thirty two antenna elements are arranged in the scanning direction and at 20 mm apart from the insulated glass when there is a matching layer and when there is no matching layer.

In FIG. 39 for TM incidence, when the gain waveform of the real model C32m (d20) with the matching layer indicated by the solid line is compared with the gain waveform of the real model E32m (d20) without the matching layer indicated by the dotted line, the waveform of the configuration with the matching layer indicated by the solid line is better especially for the gains at the target angles of 50° and 60°. It can be said that the peak gain at the target angle is also improved at the angle at which the transmission coefficient S21 has been greatly improved by providing the matching layer in FIG. 37. Furthermore, as illustrated in FIG. 37, since the transmission coefficients S21 generally increase at all angles, the influence of the ripple is less likely to occur at all angles, and it can be said that noise in the gain waveform indicated by the solid line in FIG. 39 is reduced as compared with noise in the gain waveform indicated by the dotted line.

Although FIG. 2 illustrates an example in which the matching layer 50 is attached in contact with the insulated glass 30, the matching layer 50 may be provided apart from both the window glass and the antenna.

As indicated by the dotted line in FIG. 38 and FIG. 39, in the real models E32e (d20) and E32m (d20) having no matching layer, gains having a mountain-shaped maximum value (peak) appear at positions close to the target angles of 0°, 10°, 20°, 30°, 40°, 50°, and 60°, and thus the matching layer may not be provided in the present disclosure.

### Example 6: Simulation of Dipole Antenna

Although an example in which the radiating element in the array antenna is a patch antenna has been described above, the antenna element constituting the array antenna in the present disclosure is not limited to a patch antenna.

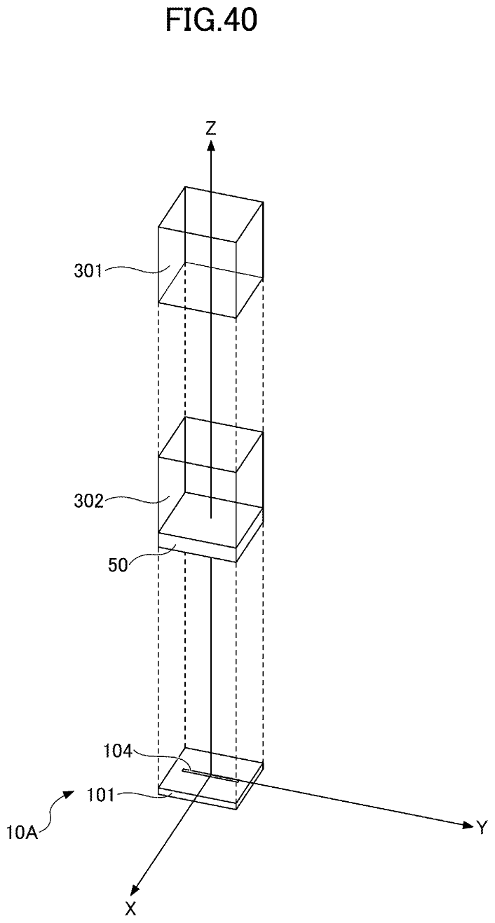

FIG. 40 is a diagram illustrating a single-element infinite periodic analysis model, which is an ideal model in a case that an antenna element constituting an array antenna is a dipole antenna element, and illustrating a model with a single gain and array factor (AF) in which a periodic boundary condition is set in the Y direction and a radial boundary condition is set in the Z direction.

As illustrated in FIG. 40, in a dipole antenna 10A, there is no ground layer (background) on the back side of the antenna substrate 101. Therefore, the unwanted mode of the radio waves due to the interference between the ground layer and the glass illustrated in FIG. 3C does not occur, and the ripple is mitigated. Therefore, the dipole antenna is generally less susceptible to noise than the patch antenna.

A real model was also created for the dipole antenna to simulate the characteristics.

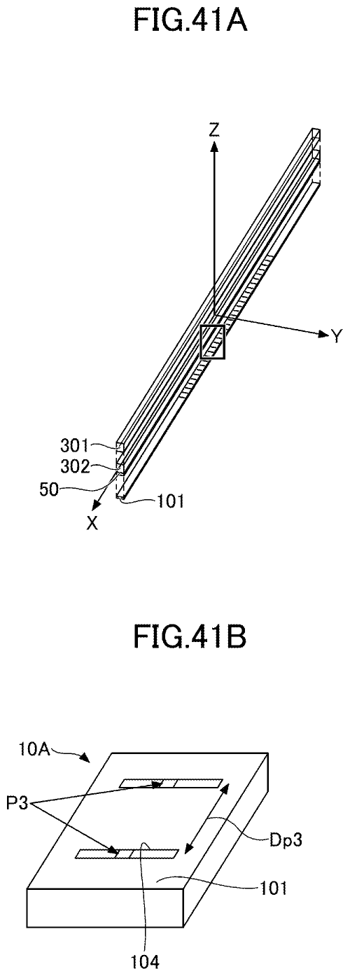

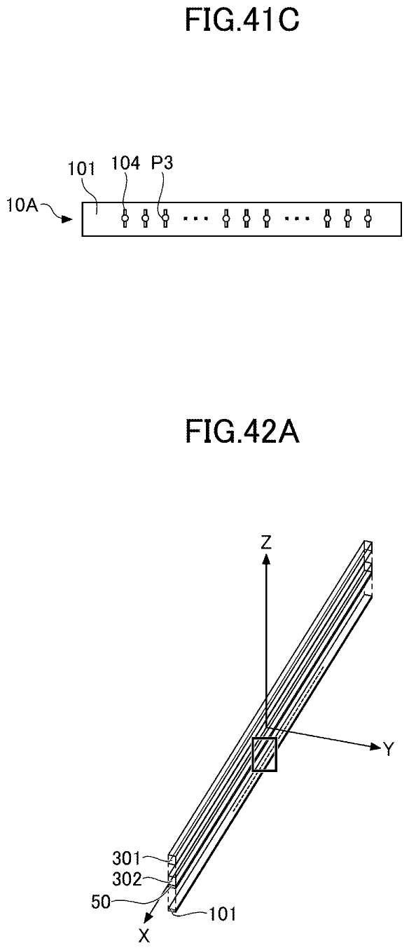

FIG. 41A to FIG. 41C are diagrams illustrating a real model Ge of the dipole antenna 10A in which multiple dipole elements 104 are arranged in the scanning direction and at a distance apart from the insulated glass when TE incidence is simulated. FIG. 41A illustrates a perspective view of the real model Ge, FIG. 41B illustrates an enlarged perspective view of a quadrilateral portion in FIG. 41A, and FIG. 41C illustrates a top view illustrating positions of feed points on the dipole antenna 10A included in the real model Ge.

In the real model Ge, a radiating element 104, which is a dipole element (dipole antenna element), extends in the Y direction. The distance between feed points P3 each provided at the center of the radiating element 104 was set to 5.4 mm.

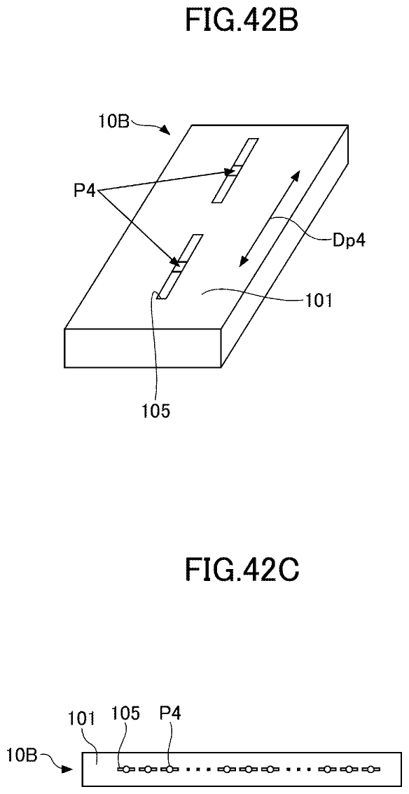

FIG. 42A to FIG. 42C are diagrams illustrating a real model Gm of a dipole antenna 10B in which dipole elements 105 are arranged in the scanning direction and at a distance apart from the insulated glass when TM incidence is simulated. FIG. 42A illustrates an overall perspective view of the real model Gm, FIG. 42B illustrates an enlarged perspective view of a quadrilateral portion in FIG. 42A, and FIG. 42C illustrates a top view illustrating positions of feed points on the dipole antenna 10B included in the real model Gm.

In the real model Gm, a radiating element 105, which is a dipole element, extends in the X direction. The distance between feed points P4 each provided at the center of the radiating element 105 was set to 5.4 mm.

In the real models Ge and Gm illustrated in FIG. 41A to FIG. 42C, the thickness, distance, and length of the substrate are the same as those in FIG. 9A to FIG. 10C.

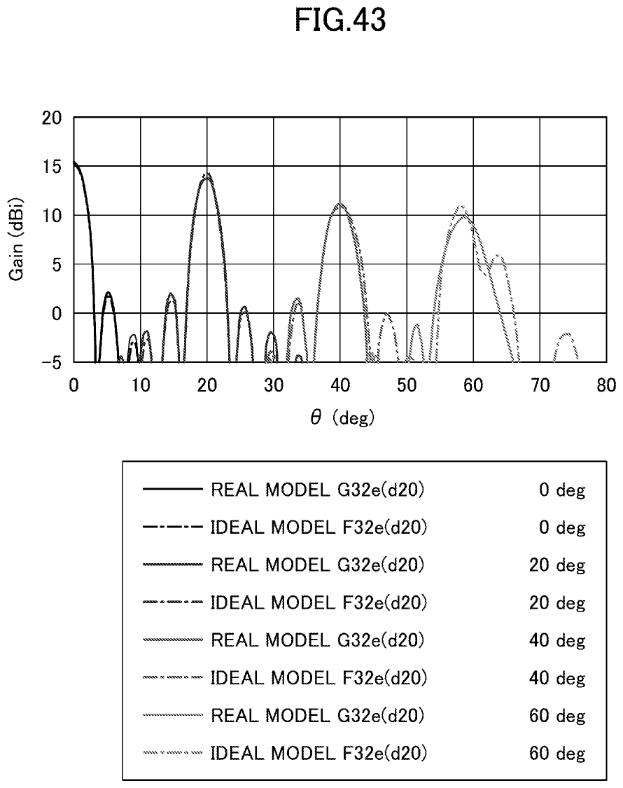

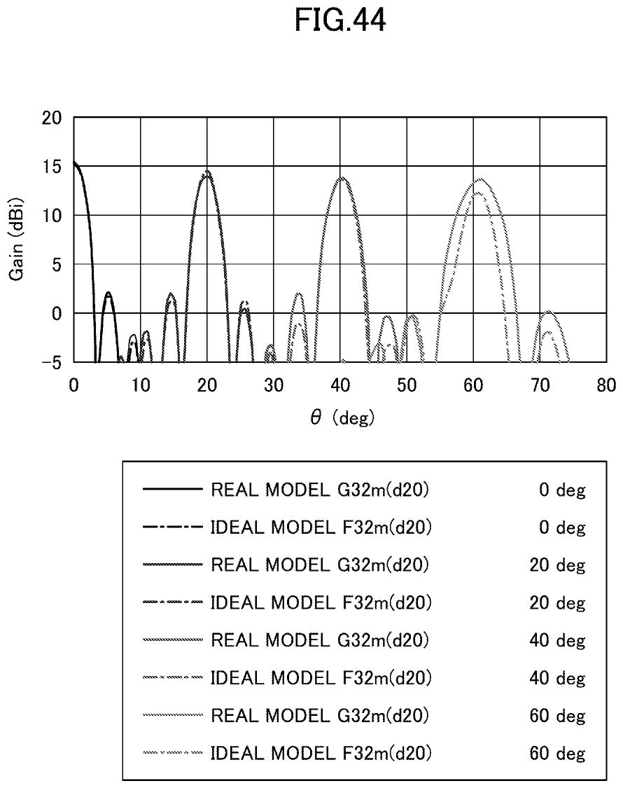

In FIG. 43 and FIG. 44 described below, the characteristics for TE incidence and TM incidence were simulated with the real models Ge and Gm of FIG. 41A to FIG. 42C, and the antenna characteristics were also simulated with the ideal model of FIG. 40. First, based on the analysis results of TE incidence and TM incidence with one element of an ideal model F which is the single-element infinite periodic analysis model in the case of the dipole antenna illustrated in FIG. 40, the antenna characteristics of ideal models F32e (d20) and F32m (d20) were simulated using the theoretical formula in the case where thirty two elements are arranged.

In a real model Ge32 (d20) having thirty two radiating elements (dipole elements) 104 illustrated in FIG. 41A to FIG. 41C and having the antenna-glass distance d of 20 mm, radiation gains at a frequency of 28 GHz when TE incidence was performed by feeding and exciting thirty two feed points P3 were simulated. FIG. 43 is a graph illustrating the gains of TE incidence at the target angles of 0°, 20°, 40°, and 60° in the case of the ideal model F32e (d20) and in a case where thirty two dipole antenna elements are arranged in the scanning direction and at 20 mm apart from the insulated glass.

In a real model Gm32 (d20) having thirty two radiating elements (dipole elements) 105 illustrated in FIG. 42A to FIG. 42C and having the antenna-glass distance d of 20 mm, radiation gains at a frequency of 28 GHz when TM incidence was performed by feeding and exciting thirty two feed points P4 were simulated. FIG. 44 is a graph illustrating the gains of TM incidence at the target angles of 0°, 20°, 40°, and 60° in the case of the ideal model F32m (d20) and in the case where thirty two dipole antenna elements are arranged in the scanning direction and at 20 mm apart from the insulated glass.

As illustrated in FIG. 43 and FIG. 44, when the gain waveforms of the infinite periodic ideal models F32e (d20) and F32m (d20) indicated by the broken line and the gain waveforms of real models G32e (d20) and G32m (d20) indicated by the solid line are compared to each other, there are mountain-shaped maximum values (peaks) at positions close to the target angles of 0°, 20°, 40°, and 60°. Therefore, it is shown that, the radiation gain for each angle tends to be generally considerably similar between the ideal model F32e (d20) and the real model G32e (d20) and between the ideal model F32m (d20) and the real model G32m (d20). Furthermore, even in the radiation gain at 60° in the real models G32e (d20) and G32m (d20) indicated by the solid line, no mountain-shaped split nor distortion has occurred.

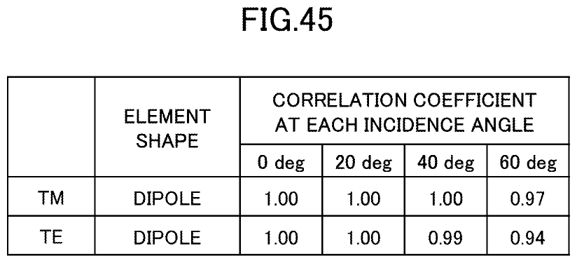

FIG. 45 illustrates the correlation coefficients between the value in the real model and the value in the ideal model at each angle in a case where thirty two dipole antenna radiating elements are arranged at 20 mm apart from the insulated glass. Equation (2), which is the same as that used in FIG. 15, was used to calculate the correlation coefficient.

As illustrated in the table of FIG. 45, in the real models G32e (d20) and G32m (d20) of the dipole antenna having the distance d of 20 mm, the correlation coefficients are greater than or equal to 0.9 for all target angles of 0°, 20°, 40°, and 60°, for both TE incidence and TM incidence.

Accordingly, an antenna device in which radiation is performed obliquely with respect to glass can be achieved using a dipole antenna element as an antenna element (radiating element).

Furthermore, in the case of the antenna without any background conductor, the deterioration due to close arrangement of the background and the glass in FIG. 3C which is the premise does not occur. Accordingly, deterioration due to interference of radio waves caused by the close arrangement of the glass and the antenna will be slight.

Note that, in the analysis models illustrated FIG. 9A onwards, the radiating elements in the analysis model are arranged in one row in the X direction; however, in the array antenna of the present disclosure, it is preferable that at least four effective elements are arranged in each of two longitudinal and lateral directions, as illustrated in the enlarged view of FIG. 1. As described above, by arranging at least four antenna elements in both directions, the radiation characteristics of the antenna can be improved even when the scanning direction of the variable beam is set to either the vertical direction or the horizontal direction in a case where the variable beam is radiated obliquely from the antenna.

### Example 7: Simulation with Different Sizes of the Array Antenna and Different Antenna-Glass Distances

In Examples 3 and 4 described above, the analysis was performed by changing the antenna-glass distance with the analysis model having the array antenna provided with thirty two radiating elements. In this example, however, the simulation was performed by changing both the antenna-glass distance and the number of elements included in the array antenna.

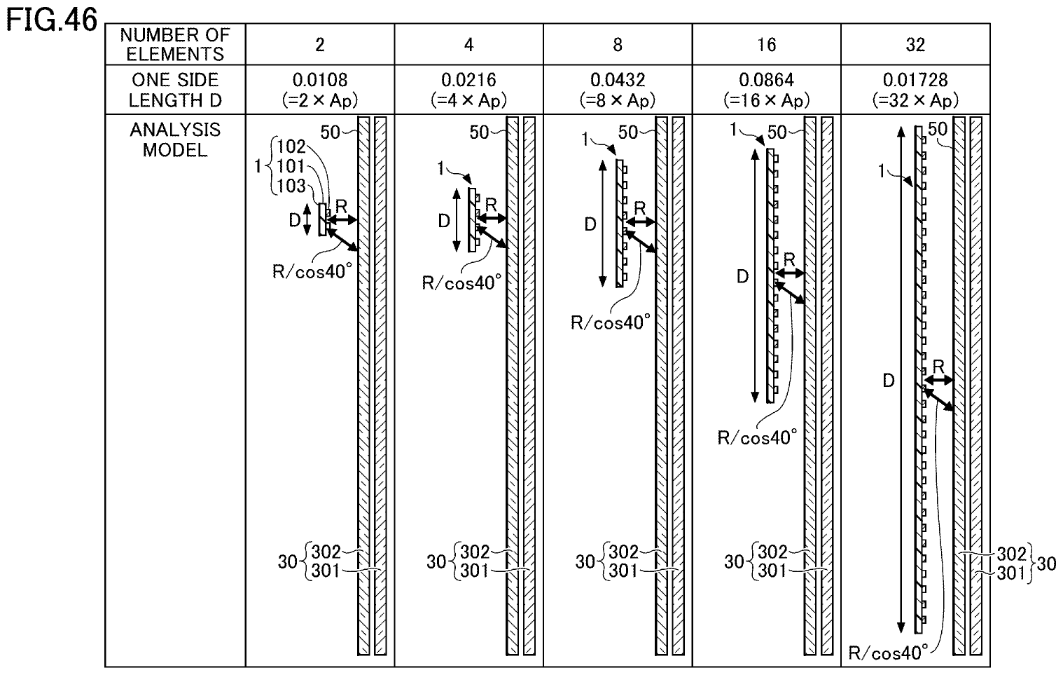

FIG. 46 is an explanatory diagram of analysis models (real models) in which array antenna elements are disposed at a distance apart from the insulated glass with the matching layer. In the analysis model, the insulated glass 30 constituted by two glass plates was used as window glass. The analysis model having thirty two elements illustrated in FIG. 46 has the same element arrangement as that of the real model B illustrated in FIG. 5, but has a different length of the beam scanning plane of the antenna substrate.

In FIG. 46, assuming that the thicknesses of the glass plates are T301 and T302, and set as follows:
T301, T302: 6 mm;
GT: 12 mm;
T50: 1 mm; and
T101: 1 mm.

The distance between the T301 and the T302 was set as 12 mm.

In the analysis model in FIG. 46, the beam scanning direction, which is the changing direction of the variable beam radiated from the antenna, is in the Y direction, and the length of the beam scanning direction of the insulated glass 30 and the matching layer 50 was set as 420 mm (0.42 m).

As illustrated in FIG. 46, an element interval (distance between two elements) Ap is set to 0.0054 m, and the distance corresponds to “0.5 ₀”. Here, the element interval Ap corresponds to a repeating unit of the substrate on which one radiating element is provided as illustrated in FIG. 4. Accordingly, when the element interval is denoted as Ap, as illustrated in FIG. 46, a length of a side of the array antenna in a case where two radiating elements are arranged in the scanning direction is 2 Ap, a length of a side thereof in a case where four radiating elements are arranged is 4 Ap, a length of a side thereof in a case where eight radiating elements are arranged is 8 Ap, a length of a side thereof in a case where sixteen radiating elements are arranged is 16 Ap, and a length of a side thereof in a case where thirty two radiating elements are arranged is 32 Ap.

In general, the element interval Ap is set to less than or equal to 0.70 λ₀ as a condition that no grating appears in the beam variable range. The range of Ap is preferably between 0.30 λ₀ and 0.70 λ₀, inclusive, more preferably between 0.4 λ₀ and 0.5 λ₀, inclusive, and still more preferably between 0.45 λ₀ and 0.55 λ₀, inclusive.

Note that, in the cross-sectional view of the analysis model in FIG. 46, the radiating element 102 of the antenna device 1 which is an array antenna is a square patch element having a width in the paper depth direction, and a feed point is provided at the center in the Y direction and on the end side in the depth direction (−X direction) in each radiating element to radiate a TE wave.

First, in the same manner as in Example 3, 5 mm, 10 mm, 20 mm, 30 mm, 40 mm, and 50 mm are set as the distance d of the ideal model A (see FIG. 4 and FIG. 6), which is the single-element infinite periodic analysis model for an insulated glass, and TE incidence with one element is analyzed for each distance d. In the ideal model of any distances, since the original single-element infinite periodic analysis model simulates the element directivity (element characteristics) by arranging N antenna elements and dividing the N antenna elements by N, almost no deterioration illustrated in FIG. 3A to FIG. 3C is involved. Based on the analysis results, the antenna characteristics (gains) of 60 patterns of ideal models in which two elements, four elements, eight elements, sixteen elements, and thirty two elements were arranged at two target angles of 0° and 40° were simulated by using the theoretical formula.

As illustrated in FIG. 46, the inventors of the present disclosure examined characteristics of the analysis models in which two, four, eight, sixteen, and thirty two antenna elements are arranged in the scanning direction and the insulated glass is disposed facing the antenna elements, while changing an antenna-glass distance R and the target angle in the beam scanning direction.

Specifically, although not illustrated in the graph, the inventors of the present disclosure changed the antenna-glass distance R in six stages of 5 mm, 10 mm, 20 mm, 30 mm, 40 mm, and 50 mm in the five analysis models (real models and ideal models) of FIG. 46, and simulated the gains at 28 GHz for 60 patterns of TE incidence at two target angles of 0° and 40°.

### Correlation for Each Number of Elements

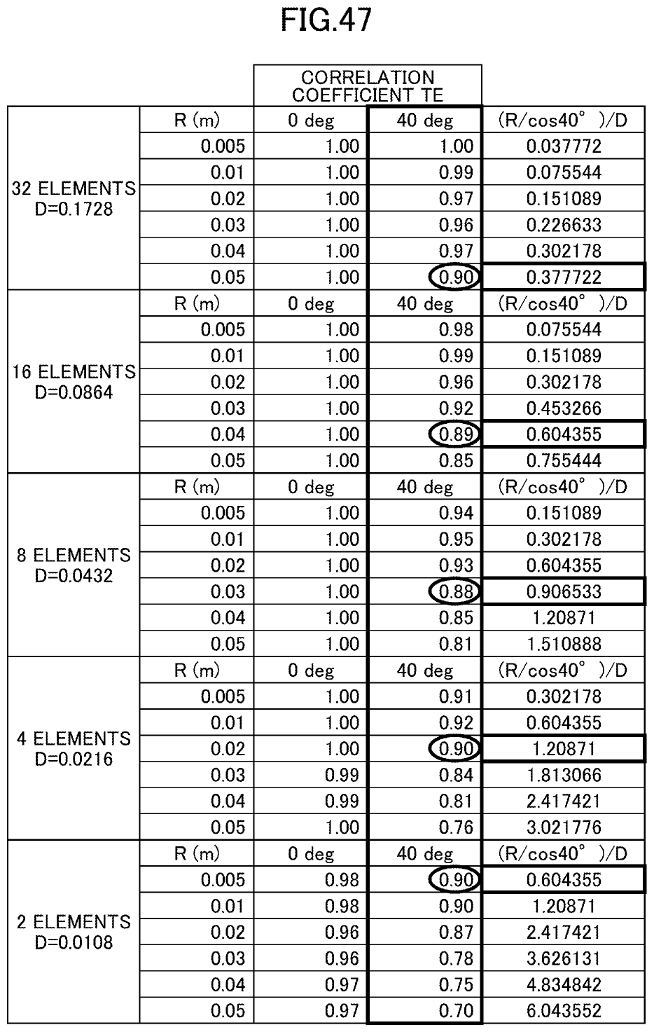

FIG. 47 is a table illustrating correlation coefficients between the value in the real model and the value in the ideal model at an angle in a case where a number of antenna elements is arranged at a distance apart from the insulated glass, the number of antenna elements being two, four, eight, sixteen, and thirty two, and the distance being 5 mm, 10 mm, 20 mm, 30 mm, 40 mm, and 50 mm.

The correlation coefficient between, at each angle, the value in the real model and the value in the ideal model was calculated in increments of 0.5° in a range of 0° to 90° using Equation (2) as in FIG. 15, and FIG. 47 illustrates the calculated correlation coefficients.

Here, as described above, in the antenna having multiple radiating elements, the direction (target angle) of the beam is set by changing the excitation phase of feeding to the feed point; however, as illustrated in FIG. 46, the substantial distance from the center point of the array antenna in the scanning direction to the window glass changes according to the angle when the target angle of the beam is other than 0°.

Specifically, when the shortest distance from the center point of the array antenna 10 in the scanning direction to the window glass 40 at the target angle of 0° is R, the substantial distance at the target angle of 40° is “R/cos40°”.

Here, according to the table of FIG. 47, the following tendencies are found:
(1) At the target angle 40°, the correlation coefficient is smaller and the deviation between the value in the ideal model and the value in the real value is larger than those at the target angle 0°. That is, as the target angle increases, the correlation coefficient decreases and the deviation between the value in the ideal model and the value in the real value increases.
(2) For any numbers of elements, as the antenna-window glass distance R decreases, the deviation between the value in the ideal model and the value in the real value increases.
(3) In both cases of the target angle of 0° and the target angle of 40°, as the number of elements decreases, the deviation between the value in the ideal model and the value in the real model increases.

Thus, it can be seen that there is regularity in characteristics between the size of the array antenna and the antenna-glass distance. Here, the following analysis was performed focusing on the target angle of 40°.

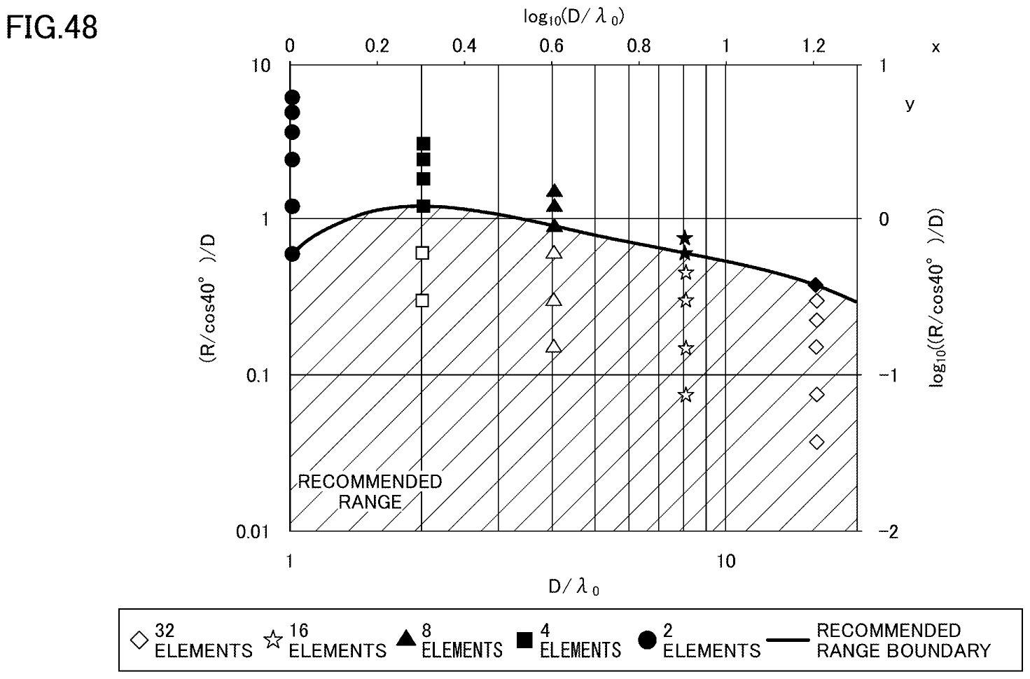

FIG. 48 is a diagram explaining a recommended range of the antenna-window glass distance depending on the size of the array antenna. The values in the thick frame in the table of FIG. 47 are plotted in FIG. 48 where the horizontal axis represents D/λ₀ (bottom horizontal row) and the vertical axis represents (R/cos40°)/D (left vertical row).

Furthermore, in FIG. 48, a curve graph is a graph obtained by analyzing, in Log₁₀, a numerical value (a numerical value in the thick frame in the rightmost column in FIG. 47) of the maximum distance R at which the correlation coefficient is less than 0.905 for each analysis model, among the numerical values in the table in FIG. 47. The curve graph in FIG. 48 is formed by taking values in the thick frame in the table in FIG. 47 where the horizontal axis represents log₁₀(D/λ0) (upper horizontal row) and the vertical axis represents log₁₀((R/cos40°)/D) (right vertical row).

Here, in a case where
a wavelength of a predetermined frequency of a radio wave in the air is denoted as λ₀;
an interval between adjacent radiating elements among at least four radiating elements is denoted as Ap=0.5×λ₀;
a number of radiating elements arranged in the beam scanning direction is denoted as Na;
a length of one side of the array antenna is denoted as D=Ap×Na; and
a shortest distance between the at least four radiating elements and the first principal surface is denoted as R,
then it is preferable if the shortest antenna-glass distance R and the length D of one side of the array antenna are set in a range which satisfies y<−1.7845x⁴+5.5378x³−6.2546x²+2.4577x−0.2271, where
y=log₁₀((R/cos40°/D), and
x=log₁₀(D/λ₀).

By being set within such a recommended range, the antenna-window glass distance can be appropriately adjusted depending on the size of the array antenna.

According to the recommended range represented by the above formula, as illustrated in FIG. 47, the recommended range of the shortest distance R increases as the number of radiating elements increases in the case where there are at least four radiating elements. For example, according to the recommended range represented by the above formula, as illustrated in FIG. 47, the following can be said in the case where there are at least four radiating elements: the shortest distance R is particularly preferably 0.005 to 0.01 mm when there are four radiating elements on one side, the shortest distance R is particularly preferably 0.005 to 0.02 mm when the number of radiating elements is eight, the shortest distance R is particularly preferably 0.005 to 0.03 mm when the number of radiating elements is sixteen, and the shortest distance R is particularly preferably 0.005 to 0.04 mm when the number of radiating elements is thirty two.

Note that, in the analysis models illustrated FIG. 9A onwards, the radiating elements in the analysis models are arranged in one row in the X direction; however, in the array antenna of the present disclosure, it is preferable that at least four effective elements are arranged in each of two longitudinal and lateral directions, as illustrated in the enlarged view of FIG. 1. In such a case where at least four antenna elements are arranged in both the X direction and the Y direction, the directions (target angles) of the beams can be set by changing the excitation phase of feeding to the feed points with respect to the radiating elements which are arranged in the scanning direction to which the variable beam is changed according to the target direction of the beam without interfering with each other. As described above, by arranging at least four antenna elements in both directions, the radiation characteristics of the antenna can be improved even if the scanning direction of the variable beam is set to either the vertical direction or the horizontal direction in a case where the variable beam is radiated obliquely from the antenna.

Although the antenna device according to the exemplary embodiment of the present disclosure has been described above, the present disclosure is not limited to the specifically disclosed embodiment, and various modifications and changes can be made without departing from the scope of the claims.

What is claimed is:

1. An antenna device comprising an array antenna configured to radiate a radio wave,
wherein the array antenna includes at least four radiating elements arranged substantially parallel to a beam scanning plane of the radio wave, and
wherein the at least four radiating elements are arranged substantially parallel to a first principal surface of window glass for a building, with the antenna device arranged such that the array antenna is arranged at the first principal surface of the window glass in a non-contact manner and such that the radio wave is radiated toward a second principal surface of the window glass opposite from the first principal surface.

2. The antenna device according to claim 1, wherein the array antenna is disposed apart from the window glass by less than or equal to 5 λ₀ where λ₀ is a wavelength of a predetermined frequency of the radio wave in air.

3. The antenna device according to claim 1, wherein in a case where
the wavelength of the predetermined frequency of the radio wave in air is denoted as λ₀;
an interval between adjacent radiating elements among the at least four radiating elements is denoted as Ap;
a number of radiating elements arranged in a beam scanning direction is denoted as Na;
a length of one side of the array antenna is denoted as D=Ap×Na; and
a shortest distance between the at least four radiating elements and the first principal surface is denoted as R,
then, the shortest distance R and the length D are set in a range satisfying y<−1.7845x⁴+5.5378x³−6.2546x²+2.4577x−0.2271, where
y=log₁₀((R/cos40°)/D), and
x=log₁₀(D/λ₀).

4. The antenna device according to claim 1, further comprising a dielectric layer disposed between the window glass and the array antenna.

5. The antenna device according to claim 4, wherein the dielectric layer is disposed apart from the array antenna and is in contact with the window glass.

6. The antenna device according to claim 4, wherein the dielectric layer is disposed apart from the array antenna and the window glass.

7. The antenna device according to claim 1, wherein the array antenna is an antenna with a ground layer.

8. The antenna device according to claim 1, wherein the array antenna is an antenna without a ground layer.

9. The antenna device according to claim 1, wherein a frequency band of the radio wave is a UHF band ranging from 0.3 to 3 GHz, an SHF band ranging from 3 to 30 GHz, or an EHF band ranging from 30 to 300 GHz.

10. Window glass for a building, comprising:
a glass plate having a first principal surface and a second principal surface opposite from the first principal surface; and
an array antenna disposed at the first principal surface in a non-contact manner and configured to radiate a radio wave toward the second principal surface,
wherein the array antenna includes at least four radiating elements arranged substantially parallel to the first principal surface and substantially parallel to a beam scanning plane of the radio wave.

11. The window glass for a building according to claim 10, wherein the array antenna is disposed apart from the glass plate by less than or equal to 5 λ₀ where λ₀ is a wavelength of a predetermined frequency of the radio wave in air.

12. The window glass for a building according to claim 10, wherein in a case where
the wavelength of the predetermined frequency of the radio wave in air is denoted as λ₀;
an interval between adjacent radiating elements among the at least four radiating elements is denoted as Ap;
a number of radiating elements arranged in a beam scanning direction is denoted as Na;
a length of one side of the array antenna is denoted as D=Ap×Na; and
a shortest distance between the at least four radiating elements and the first principal surface is denoted as R,
then, the shortest distance R and the length D are set in a range satisfying y<−1.7845x⁴+5.5378x³−6.2546x²+2.4577x−0.2271, where
y=log₁₀((R/cos40°)/D), and
x=log₁₀(D/λ₀).

13. The window glass for a building according to claim 10, wherein the glass plate is an insulated glass including a plurality of glass plates.

14. The window glass for a building according to claim 10, wherein the glass plate is constituted by one glass plate.

15. The window glass for a building according to claim 10, further comprising
a conductive film laminated on the glass plate,
wherein the conductive film has an opening in a region facing the array antenna.
